(19) United States
(12) Patent Application Publication
(10) Pub. No.: US 2016/0379105 A1
(43) Pub. Date: Dec. 29, 2016

(54) BEHAVIOR RECOGNITION AND AUTOMATION USING A MOBILE DEVICE

(71) Applicant: Microsoft Technology Licensing, LLC, Redmond, WA (US)

(72) Inventors: Larry Richard Moore, Jr., Redmond, WA (US); Valerie Wang, Bellevue, WA (US); Sandeep Sahasrabudhe, Kirkland, WA (US)

(21) Appl. No.: 14/748,912

(22) Filed: Jun. 24, 2015

(51) Int. Cl. G06N 3/00; G06F 3/01; G06N 7/00; G06F 3/0481; G06N 99/00; G06F 3/16; G06F 3/0484

(52) U.S. Cl. CPC G06N 3/006; G06F 3/167; G06F 3/017; G06F 3/0484; G06F 3/0481; G06N 99/005; G06N 7/005

(57) ABSTRACT

Signals representing local events and/or state are captured at a mobile device and utilized by a machine learning system to recognize patterns of user behaviors and make predictions to automatically launch an application, initiate within-application activities, or perform other actions. The local signals may include, for example, location information such as geofence crossings; alarm settings; use of network connections like Wi-Fi, cellular, and Bluetooth®; device state such as battery level, charging status, and lock screen state; device movement indicating that the device user may be driving, walking, running, or stationary; audio routing such as headphones being used; telemetry data from other devices; and application state including launches and within-application activities. A feedback loop is supported in which the machine learning system may utilize feedback from the user as part of a learning process to adapt and tune the system's predictions to improve the relevance of the predictions.

### BACKGROUND

Computers and mobile devices such as smartphones, wearable devices, and tablets provide a wide variety of functions and features that are beneficial to users and make it easier to perform tasks and get information.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Signals representing local events and/or state are captured at a mobile device such as a wearable computing platform, smartphone, tablet computer, and the like and utilized by a machine learning system to recognize patterns of user behaviors and make predictions to automatically launch an application, initiate within-application activities, or perform other actions. A feedback loop is supported in which the machine learning system may utilize feedback from the user as part of a learning process to adapt and tune the system's predictions to improve the relevance of the predictions. Accordingly, for example, a user may regularly engage in an exercise routine that involves driving from home to the gym, starting a music application and initiating a playlist from within the application, starting a fitness application and initiating a saved workout session from within the fitness application, performing a workout, and then stopping the applications. Such recurring pattern of behaviors is identified by the machine learning system so that the next time the user drives from home to the gym, the applications can be launched and the within-application activities initiated on behalf of the user in an automated manner.

In various illustrative examples, the local signals may include, for example, location information such as geofence crossings, alarm settings, use of network connections like Wi-Fi; cellular; and Bluetooth®; device state such as battery level, charging status, and lock screen state; device movement indicating that the device user may be driving, walking, running, or stationary; audio routing such as headphones being used; telemetry data from other devices; and application state including launches and within-application activities. The machine learning system may be configured to interoperate with a digital assistant with which the device user may interact to receive information and services. An application programming interface (API) can be exposed so that within-application activity usage patterns of instrumented applications can be monitored and utilized by the machine learning system to make predictions and trigger automated actions. Cloud-based services and resources can also be utilized to support the local machine learning system and implement various features and user experiences.

A behavioral learning engine in the machine learning system can operate to analyze the local signals and/or within-application events to identify particular chains of events that have a greater-than-average probability of ending in an application launch. Tree structures are populated in a probabilistic directed graph having Bayesian network characteristics to enable calculations of a probability of event occurrence given previous event history.

The present behavior recognition and automation enables enhanced services and experiences to be delivered to the mobile device and improves the efficiency with which the user may interact with the device in typical implementations. In addition, the operation of the mobile device itself is improved because the machine learning system's predictive actions to launch applications and/or within-application activities tends to use device resources such as battery power, memory, and processing cycles in a more efficient manner compared with manual and other techniques. For example, the mobile device may collect signals over some time interval that enable the machine learning system to recognize that the user generally exercises while listening to music from a particular playlist whenever the user is at the park on weekend afternoons. When the user plugs in a set of headphones and prepares to run, the system automatically launches fitness music player applications. The system navigates to the playlist, sets the volume to the user's usual level, and then starts the music playback. The user saves time and effort by not having to manually perform the various launch, navigation, settings, and start activities. By reducing opportunities for user input errors that typically accompany manual operations, the machine learning system's automated predictive activities improve overall mobile device function and conserves resources which are often limited. For example, reduced usage of the screen may conserve power. In addition, the probabilistic directed graph utilized by the behavioral learning engine is computationally efficient which can further reduce resource loading on the mobile device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative environment in which mobile devices can interact with one or more communication networks;

FIG. 2 shows an illustrative machine learning system that uses local signals collected at a mobile device;

FIG. 3 is a taxonomy of illustrative local signals;

FIG. 4 is a taxonomy of illustrative within-application events;

FIG. 5 shows an illustrative user feedback loop that may be utilized as an input to a machine learning system;

FIG. 6 shows an illustrative use scenario in which a mobile device user participates in activities and interacts with various applications;

FIG. 7 shows an illustrative use scenario in which a machine learning system and digital assistant provide automated actions to support enhanced user experiences and improved mobile device operations;

FIG. 8 shows an illustrative architecture for a machine learning system on a mobile device;

FIG. 9 shows illustrative events that are used to highlight various aspects of the machine learning system;

FIGS. 10-21 show illustrative graphs that may be utilized by the machine learning system;

FIGS. 22-24 show flowcharts of illustrative methods that may be performed when implementing the present behavior recognition and automation;

FIG. 25 shows illustrative inputs to a digital assistant and an illustrative taxonomy of general functions that may be performed by a digital assistant;

FIGS. 26, 27, and 28 show illustrative interfaces between a user and a digital assistant;

FIG. 29 is a simplified block diagram of an illustrative computer system such as a personal computer (PC) that may be used in part to implement the present behavior recognition and automation;

FIG. 30 shows a block diagram of an illustrative device that may be used in part to implement the present behavior recognition and automation; and

FIG. 31 is a block diagram of an illustrative mobile device.

### Like reference numerals indicate like elements in the drawings. Elements are not drawn to scale unless otherwise indicated.

### DETAILED DESCRIPTION

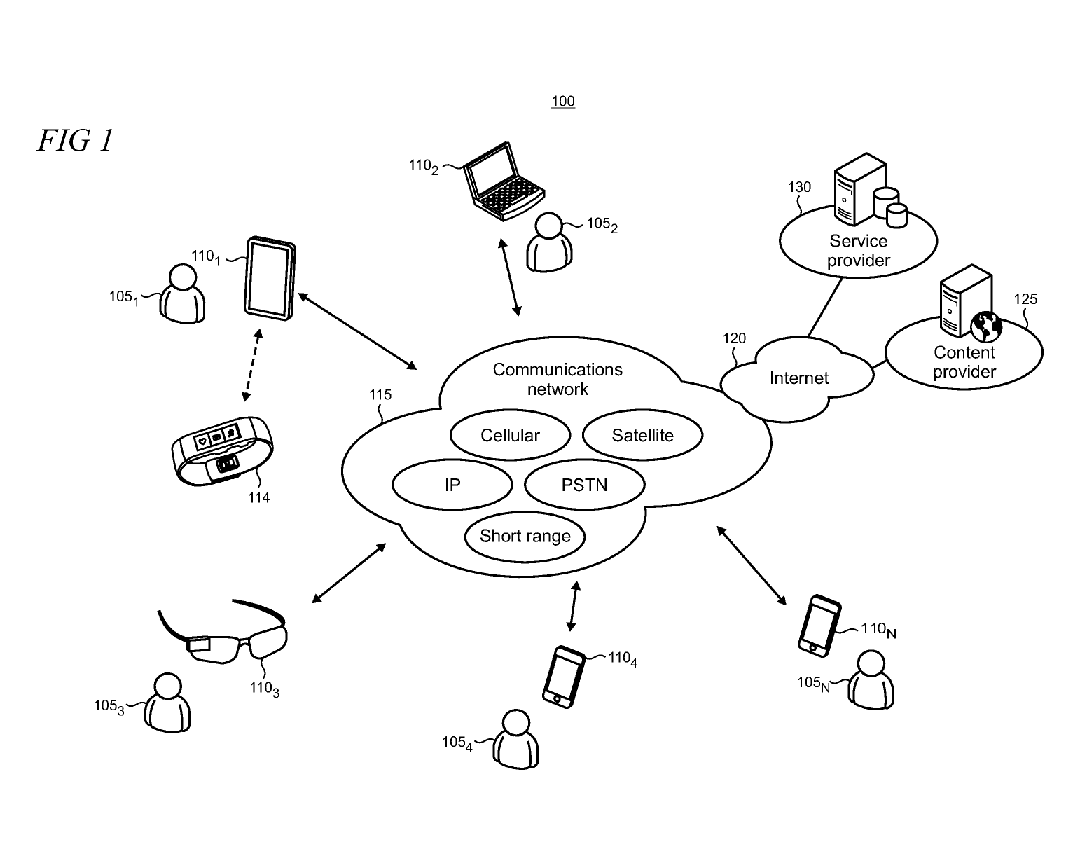

FIG. 1 shows an illustrative environment 100 in which various users 105 employ respective mobile devices 110 that communicate over a communications

network 115. The devices 110 may typically support communications using one or more of text, voice, or video and support data-consuming applications such as Internet browsing and multimedia (e.g., music, video, etc.) consumption in addition to providing various other features. The devices 110 may include, for example, user equipment, mobile phones, cell phones, feature phones, tablet computers, laptops, notebooks, and smartphones which users often employ to make and receive voice and/or multimedia (i.e., video) calls, engage in messaging (e.g., texting) and email communications, use applications and access services that employ data, browse the World Wide Web, and the like.

However, alternative types of mobile or portable electronic devices are also envisioned to be usable within the communications environment 100 so long as they are configured with communication capabilities and can connect to the communications network 115. Such alternative devices variously include handheld computing devices; PDAs (personal digital assistants); portable media players; devices that use headsets and earphones (e.g., Bluetooth-compatible devices); phablet devices (i.e., combination smartphone/tablet devices); wearable computers including head mounted display (HMD) devices, bands, watches, and other wearable devices (which may be operatively tethered to other electronic devices in some cases); navigation devices such as GPS (Global Positioning System) systems, laptop PCs (personal computers); gaming systems; or the like. In the discussion that follows, the use of the term “device” is intended to cover all devices that are configured with communication capabilities and are capable of connectivity to the communications network 115.

The various devices 110 in the environment 100 can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, and voice commands, while others may enable a more limited UI. Some devices may support video consumption and Internet browsing, while other devices may support more limited media handling and network interface features.

As shown, the devices 110 can access the communications network 115 in order to implement various user experiences. The communications network can include any of a variety of network types and network infrastructure in various combinations or sub-combinations including cellular networks, satellite networks, IP (Internet-Protocol) networks such as Wi-Fi and Ethernet networks, a public switched telephone network (PSTN), and/or short range networks such as Bluetooth® networks. The network infrastructure can be supported, for example, by mobile operators, enterprises, Internet service providers (ISPs), telephone service providers, data service providers, and the like. The communications network 115 typically includes interfaces that support a connection to the Internet 120 so that the mobile devices 110 can access content provided by one or more content providers 125 and access a service provider 130 in some cases. Accordingly, the communications network 115 is typically enabled to support various types of device-to-device communications including over-the-top communications, and communications that do not utilize conventional telephone numbers in order to provide connectivity between parties.

Accessory devices 114, such as wristbands and other wearable devices may also be present in the environment 100. Such accessory device 114 typically is adapted to interoperate with a device 110 using a short range communication protocol to support functions such as monitoring of the wearer's physiology (e.g., heart rate, steps taken, calories burned, etc.) and environmental conditions (temperature, humidity, ultra-violet (UV) levels, etc.), and surfacing notifications from the coupled device 110. Some accessory devices can operate on a standalone basis as well, and may expose functionalities having a similar scope to a smartphone in some implementations, or a more restricted set of functionalities in others.

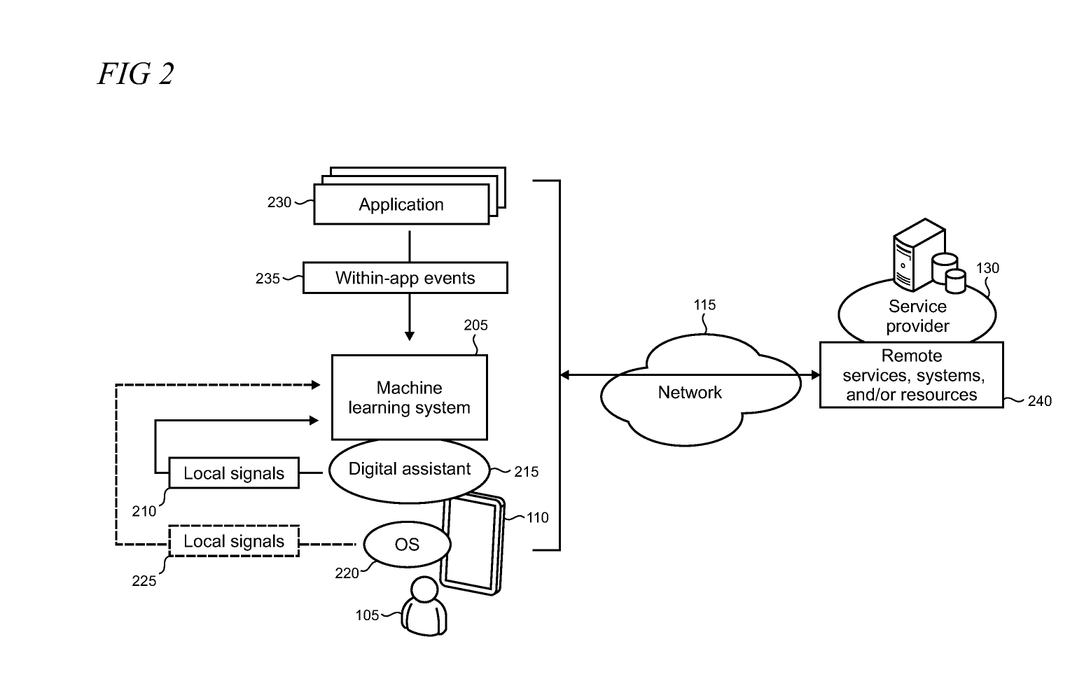

FIG. 2 shows an illustrative machine learning system 205 operating on a mobile device 110 that uses local signals 210 to support the present behavior recognition and automation. Generally, the local signals are generated, stored, and utilized subject to suitable notice to the device user and user consent so that features and user experiences of the present behavior recognition and automation can be rendered. Typically, to the extent that data about the user is needed, its collection and handling is anonymized or subjected to other processes that are configured to protect personally identifying information (PII) and strictly maintain user privacy. For example, by using local signals and a computationally efficient machine learning system, user privacy can be enhanced because data does not need to leave the mobile device. In some implementations, the machine learning system 205 may be operatively coupled or integrated with a digital assistant 215 that is exposed on the device 110 so that the local signals 210 can be provided to the system from the digital assistant. That is, the digital assistant 215 is typically configured to monitor various aspects of device operation and/or user interactions with the device in order to generate or otherwise provide some or all of the local signals. In other implementations, the operating system (OS) 220 can generate or otherwise provide local signals 225 as an alternative to the local signals 210 from the digital assistant 215 or as a supplement to those signals.

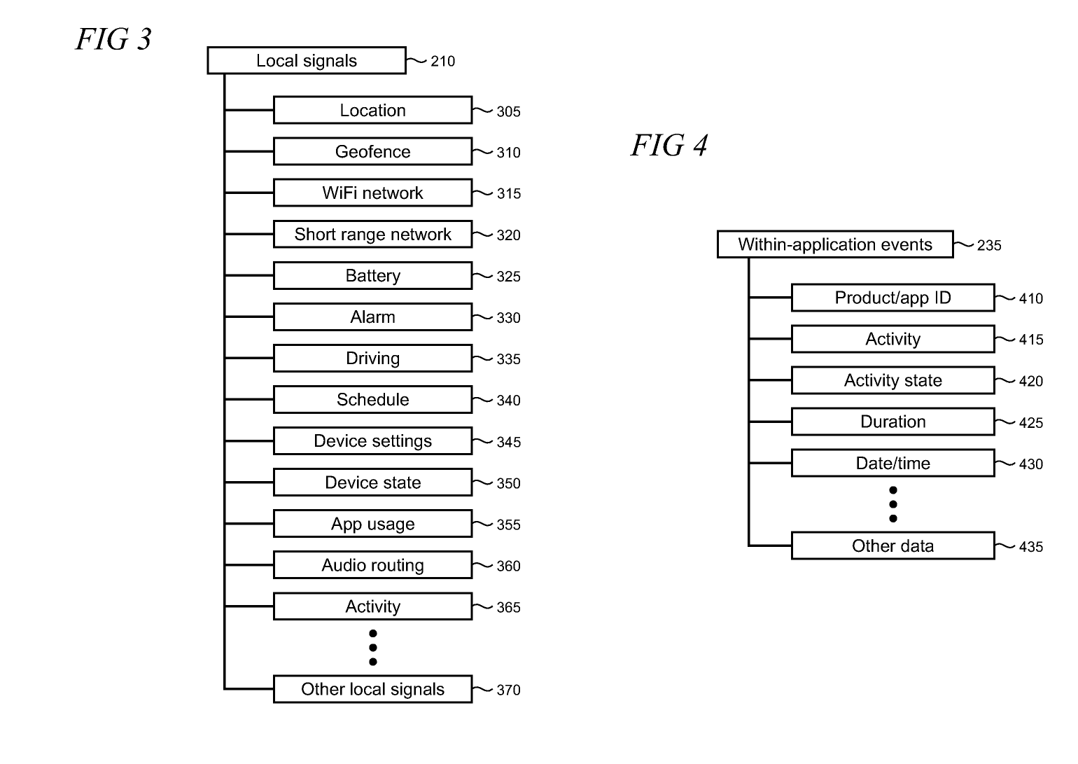

The local signals are generally related to events or state but can vary by implementation. As shown in FIG. 3, the local signals 210 may illustratively include and/or describe one or more of:
1) Device location 305;
2) Geofence 310 which includes an area typically having defined perimeter around a given geographic location;
3) WiFi network 315 connection or other wireless network connection;
4) Short range network 320 connection (e.g., Bluetooth);
5) Battery 325 which may include battery power level and charging state and/or connection to a remote power source;
6) Alarms 330 which may be set and/or pending;
7) Driving 335 which may include device and/or user interactions with a car or other vehicle, vehicle telemetry data, or the like;
8) Schedule 340 which may include appointments, reminders, meetings, events, or the like;
9) Device settings 345 which may include audio volume;
10) Device state 350 which may include a lock state of the device where a locked device typically restricts access to its features until unlocked by the user using some action such as a gesture or other input to a user interface exposed by the device;
11) Application usage 355 which may include application launches and events;
12) Audio routing 360 which may include headphone and/or speakerphone utilization;
13) Activity 365 which may indicate that the user is idle, stationary, walking, running, in a vehicle, or the like; and
14) Other local signals 370 to suit a particular implementation of application of the present behavior recognition and automation.

The examples of local signals listed above are intended to be illustrative and not exhaustive and not all of the signals have to be utilized in every implementation. Each local signal can typically generate or be associated with one or more unique events that the machine learning system may utilize. For example, the unique events can comprise one or more of the following:
1) WiFi network signals may generate a WiFi-Disconnected and a separate WiFi-Connected event for each WiFi router encountered;
2) Short range network signals may generate Bluetooth-Disconnected and a separate Bluetooth-Connected event for each short range network-enabled device encountered;
3) Alarm signals may generate Alarm-Created, Alarm-Deleted, and a separate Alarm-Fired event for each alarm GUID (Globally Unique ID);
4) Geofence signals may generate events that are unique per fence and state;
5) Audio routing signals may generate events that are unique per device ID;
6) Application usage signals may generate events that are unique per application (e.g., application launch events);
7) Battery signals may generate events that are unique per state (e.g., charging true and charging false events);
8) Device state signals may generate events that are unique per lock state (e.g., password locked, screen locked, or unlocked events);
9) Driving signals may generate events that are unique per state (e.g., driving true and driving false events); and
10) Activity signals may generate unique idle, stationary, walking, or running events.

The examples of the events listed above are intended to be illustrative and not exhaustive and not all of the events are expected to have the same usefulness in a given implementation.

Applications 230 are also typically supported on the mobile device 110 which can provide various features, capabilities, and user experiences. The applications 230 typically can include first, second, and third party products. Using instrumentation and an application programming interface (API) that is described in more detail below, the applications 230 can provide within-application events 235 to the machine learning system 205 so that particular application features or content can be automatically launched using the machine learning system. For example, a music player application may generate within-application events to indicate that the user 105 regularly selects a particular playlist of songs for playback on the device 110 when exercising. The within-application playlist can be automatically launched for future exercise sessions.

The within-application events 235 can represent application state changes or user operations but may vary by implementation. As shown in FIG. 4, the within-application events 235 may illustratively include and/or describe one or more of:
1) Product or application ID 410;
2) Activity 415 name, description, or ID;
3) Activity state 420 (e.g., start and end of an activity);
4) Activity duration 425;
5) Date/time 430; and
6) Other data 435 to suit a particular implementation.

It is emphasized that the particular within-application event data types shown in FIG. 4 are intended to be illustrative and not exhaustive. It is further emphasized that the within-application events can describe events that are associated with user interactions with an application as well as events resulting from an application's own processing and logic. Accordingly, the machine learning system 205 (FIG. 2) can be configured, in some scenarios, to use the within-application events to compare and contrast native application behaviors with the user's behavior patterns.

Returning to FIG. 2, each of the components instantiated on the mobile device 110 including the applications 230, machine learning system 205, digital assistant 215, and OS 220 may be configured in some implementations to communicate with the remote service provider 130 over the network 115. The service provider 130 can expose one or more of remote services, systems, or resources to the local components on the mobile device 110. Accordingly, a mix of local and remote code execution may be utilized at the respective local device 110 and servers at the remote service provider 130. However, in some scenarios such as those in which a connection to remote services is limited or unavailable, local code execution may be utilized substantially on its own to perform behavior recognition and automation. The particular distribution of local and remote processing may often be a design choice that is made in consideration of various applicable requirements for allocation of resources such as processing capabilities, memory, network bandwidth, power, etc. In some implementations, a device may be configured to support a dynamic distribution of local and remote processing in order to provide additional optimization of resource allocation and user experiences.

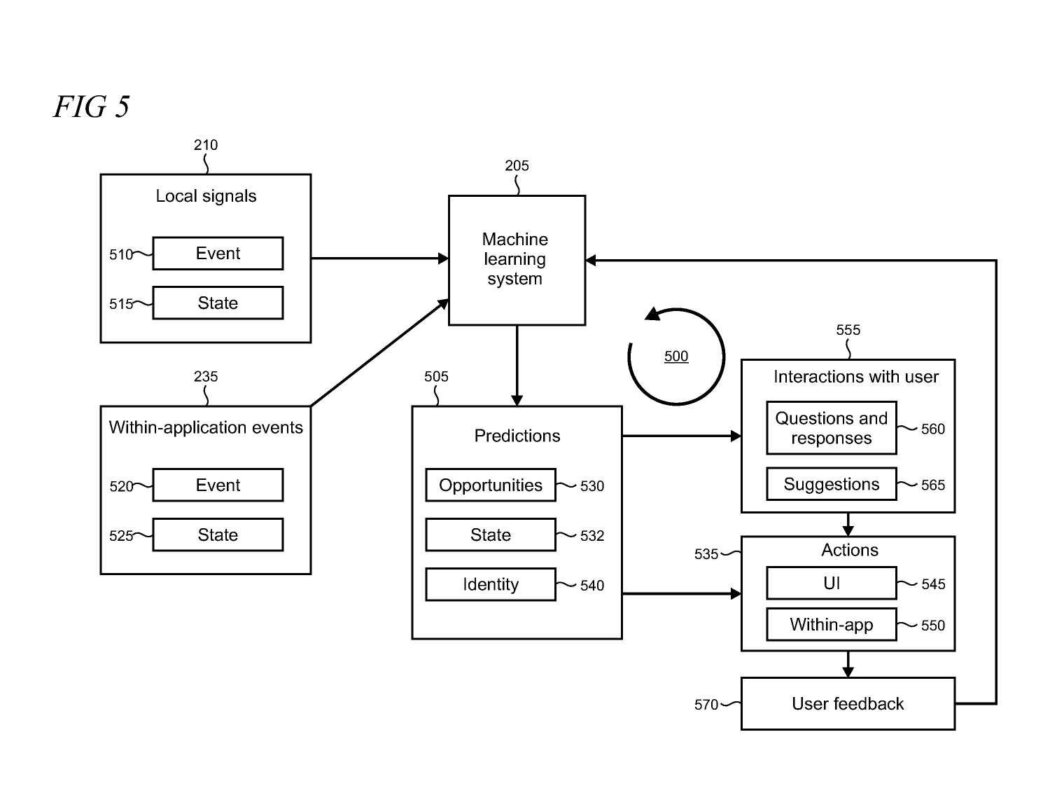

FIG. 5 shows an illustrative user feedback loop 500 that may be utilized as an input to the machine learning system 205. As shown, the machine learning system 205 uses one or more of the local signals 210 and/or within-application events 235 to generate predictions 505. As discussed above, the local signals 210 may relate to events 510 and/or state 515. For example, an event may include recognition of a particular activity, an application launch, or the like. State information may include messaging addresses, calendar data, device status, vehicle telemetry data, or the like. Likewise, within-application events 235 may relate to events 520 and state 525. For example, an event may include a user selecting a particular artist in a music application and state information can include song play count.

The predictions generated by the machine learning system 205 can illustratively include opportunities 530, state 532, and identity 540, as shown. Opportunities 530 can be associated with actions 535 that may be implemented through a user interface (UI) 545 on the device and can include launching an application or initiating within-application activities 550 such as launching a playlist, for example. State may include helpful information such as the user's car needing fuel that is obtained through vehicle telemetry data, for example. Patterns of behavior may be observed that are typical for a given user to help confirm or verify the user's identity in some cases.

In some use scenarios, before an action is initiated, interactions with the user (as indicated by reference numeral 555) are performed which may include questions and responses 560 and/or suggestions 565. Such interactions may be performed with voice using the digital assistant, for example, or using another UI to enable the user to provide feedback 570 to the machine learning system 205. Such user feedback may facilitate the measurement and improvement of the relevance of the predictions 505 while typically enhancing the overall user experience and increasing personalization.

The user feedback 570 may include observation of user responses to questions, suggestions, and/or actions. For example, the device 110 can include components configured to observe one or more of the user's facial expression, tone of voice, vocabulary used when interacting with the digital assistant, or other UI interactions to determine how a suggested action or an initiated action is received by the user. User feedback to a suggested action or an initiated action can also be gathered in an explicit or overt manner, for example, by exposing a like and/or dislike control, a voting mechanism, or detecting gestures or other UI interaction that may indicate how the user feels about the suggestions and actions.

The user feedback 570 may be arranged as another input to the machine learning system, for example in a similar manner to the local signals and/or within-application events, and is typically used in a probabilistic manner to refine the particular actions implemented or offered to a given user. Implementation of the feedback loop 500 can generally be expected to enable a higher user utilization of the digital assistant using the present behavior and automation by increasing accuracy of the predictions and reducing types and number of interactions that users tend to find distracting and irritating.

The machine learning system may be configured to “unlearn” certain suggestions and/or actions in some implementations. Such unlearning may be implemented over a time interval, for example as the user's behaviors and interests evolve and change, and may be facilitated, in whole or part, by user feedback. Other unlearning may be implemented more immediately in some cases, for example by exposing a control or receiving user feedback like “never ask me this again.”

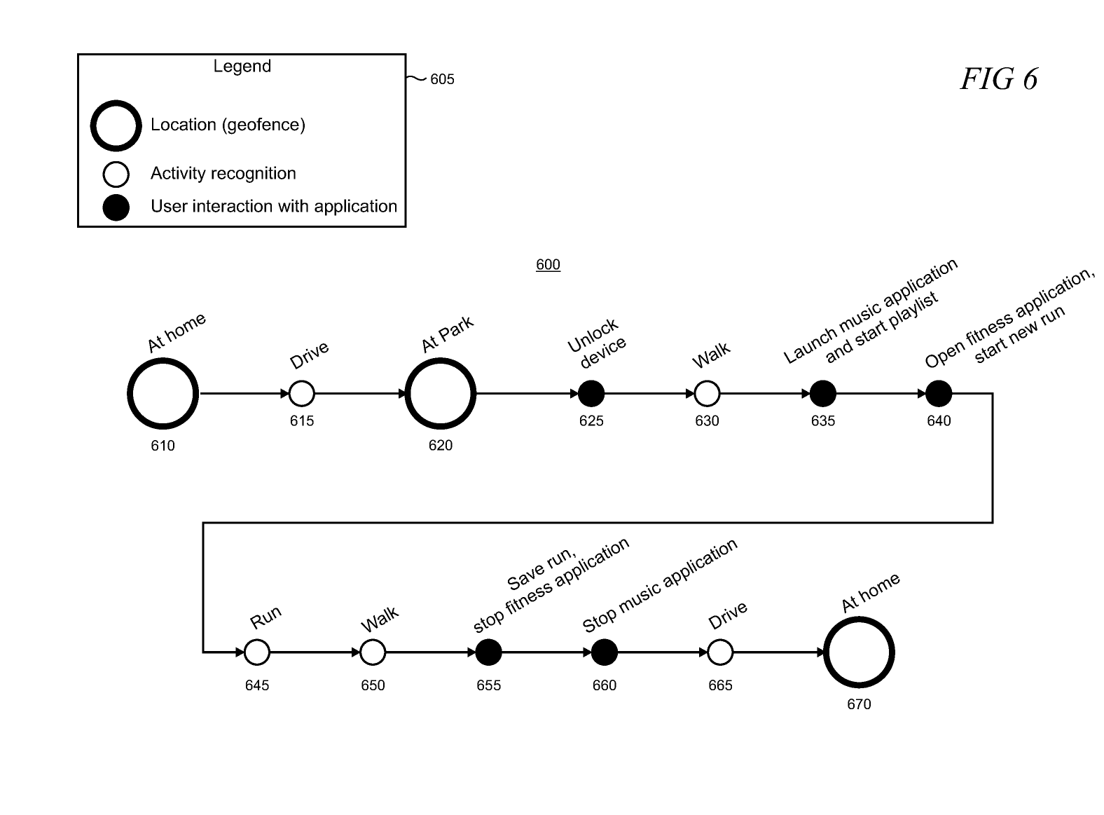

An illustrative use scenario is now presented. FIG. 6 shows a scenario 600 in which the user participates in activities and interacts with various applications. As indicated in the legend 605, the scenario 600 comprises a sequence of events that occur over a time interval including locations with associated geofences, activities that are recognized by the machine learning system using signals, and user interactions with a particular application.

The scenario begins with the user being at home (as indicated by reference numeral 610). The user then drives (615) a vehicle to a park (620). The user unlocks the mobile device (625) and starts to walk (630). The user launches a music application and starts a playlist (635) that the user usually listens to while running The user opens a fitness application and starts a new run (640) that may comprise, for example, the monitoring, analysis, and storing of various attributes, characteristics, and/or other data that are associated with that particular running session.

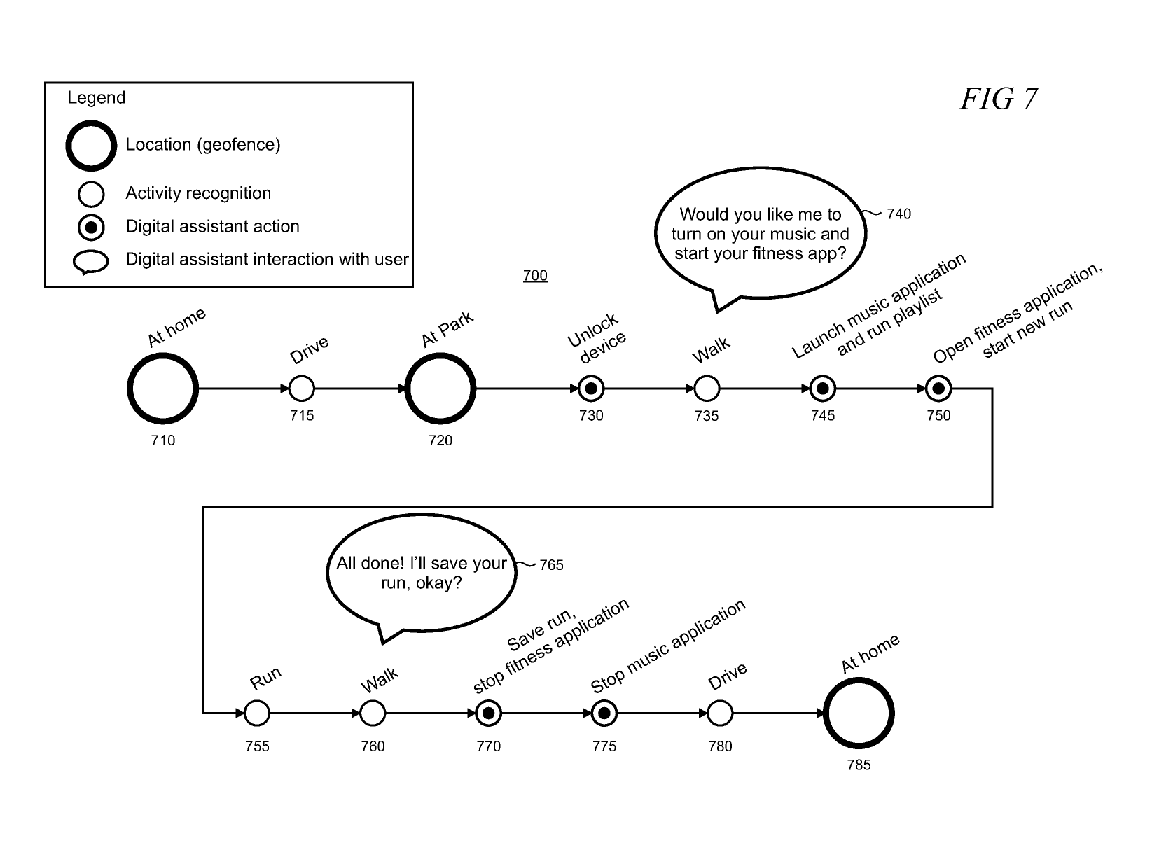

As the user continues to engage in running sessions at the park over the course of time, the machine learning system can learn enough to enable actions and/or suggestions to be automatically triggered which are relevant to the user with some level of confidence (i.e., a probability beyond some threshold) as shown in the use scenario 700 in FIG. 7. Here, the sequence of events is similar to that shown in FIG. 6—the user starts at home (710) and drives (715) to the park (720). At this point, the machine learning system signals the digital assistant to unlock the device (730). In this example, as the user starts to walk (735), the digital assistant asks the user (typically by voice as indicated by reference numeral 740, but other forms of communication may also be utilized) to confirm that a suggested action is correct. Supporting such interaction enables the user to provide positive feedback to the machine learning system. If the user responds affirmatively, for example, by responding using voice, a gesture, or other input to a device UI, then the digital assistant launches the music application and interacts within-application to launch the playlist (745) to which the user listens while running. The digital assistant also launches the fitness application and interacts within-application to start a new run (750). The user runs (755) for a time, then slows to a walk (760). At that point, the digital assistant asks the user for confirmation to save the data for the run that was just completed, as indicated by reference numeral 765. If the user responds affirmatively, the digital assistant saves the run and stops the fitness application (770). The digital assistant also stops the music application (775) and the user drives (780) from the park to get back at home (785).

As the use scenarios highlight, the automated actions performed by the digital assistant responsively to the predictions generated by the machine learning system enable the user to interact with the mobile device in a more efficient manner by reducing the chances for user error. In addition, the operation of the mobile device itself is improved because the machine learning system's predictive actions to launch applications and/or within-application activities tends to use device resources such as battery power, memory, and processing cycles in a more efficient manner compared with manual and other techniques.

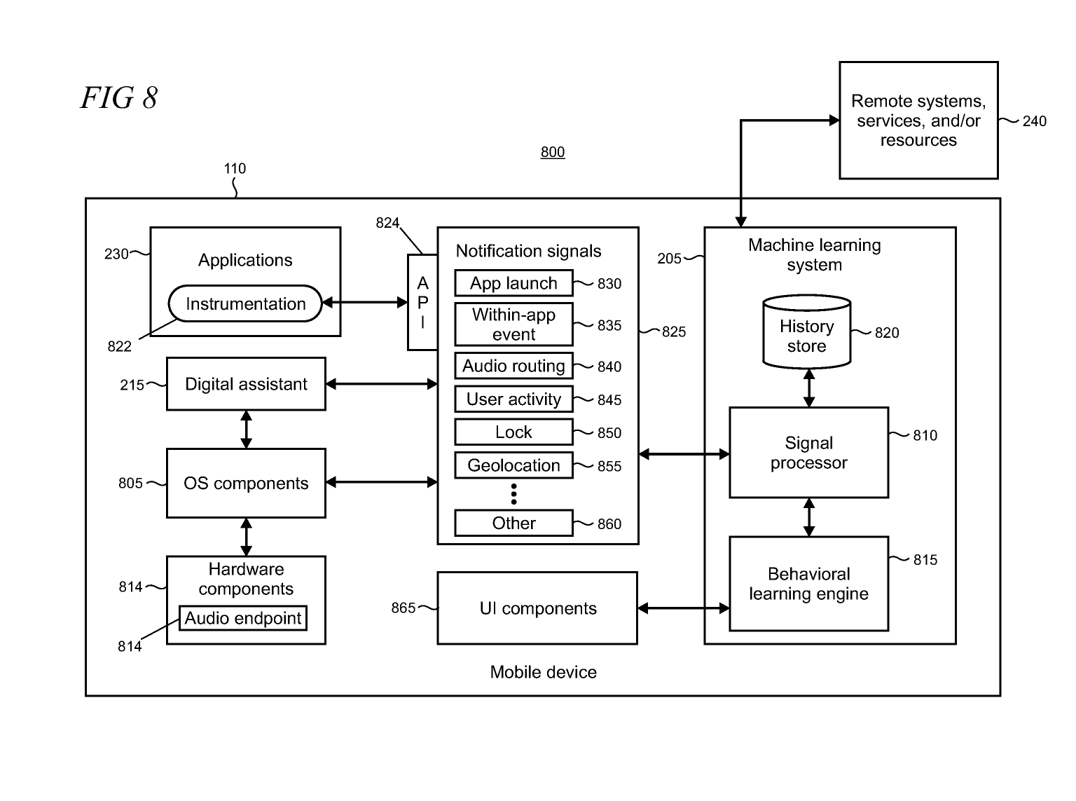

FIG. 8 shows an illustrative architecture 800 for the machine learning system 205 on a mobile device 110. The various components shown in the architecture 800 are typically implemented in software, although combinations of software, firmware, and/or hardware may also be utilized in some cases. As discussed above, the machine learning system 205 can be implemented in conjunction with the digital assistant, for example, as part of the device OS, and typically interacts with various other OS components 805. Alternatively, the machine learning system can be implemented as an application that executes partially or fully on the device 110. In some cases, the machine learning system 205 can be configured for interaction with remote systems, services, and/or resources 240, for example, to receive push notifications and other event and/or state data.

The machine learning system 205 may be configured to include a signal processor 810, a behavioral learning engine 815, and a history store 820 for storing local event and state history. The signal processor 810 may interact with notification signals 825 that are managed on the device by an OS component or other suitable functionality. As shown, the notification signals in this particular example include those relating to application launch 830, within-application activity 835, audio routing 840, user activity 845, lock 850, geolocation 855, and other notifications signals 860 that may suit a particular implementation.

A hardware component 812 provides an abstraction of the various hardware used on the device 110 (e.g., input and output devices, networking and radio hardware, etc.) to the OS and various other components in the architecture. In this illustrative example, the hardware layers support an audio endpoint 814 which may include, for example, the device's internal speaker, a wired or wireless headset/earpiece, external speaker/device, and the like.

One or more of the applications 230, including third party applications in particular, may be configured with instrumentation 820 that is arranged for interoperation with an API 824 that is exposed on the device. The instrumentation typically facilitates the collection of within-application events from a given application 230 so that specific within-application content, activities, user experiences, telemetry data, or the like can be collected and analyzed by the machine learning system. The application and particular within-application events, activities, etc. can then be automatically launched for the user at suitable times in the future.

The behavior learning engine 815 interoperates with the signal processor and various UI components 865 on the mobile device to identify recurring sequences of patterns in discrete event data contained in the signals. The behavior learning engine in this particular illustrative example uses tree structures of events to generate a probabilistic directed graph that has some Bayesian network characteristics, in that calculations of a probability of event occurrence are made given previous event history. The probabilistic directed graph is typically acyclic and enables computational efficiency which is often beneficial to the operation of mobile devices where resources tend to be limited. However, other suitable techniques using neural networks, regression, or classification for example, may also be applied according to the needs of a particular implementation.

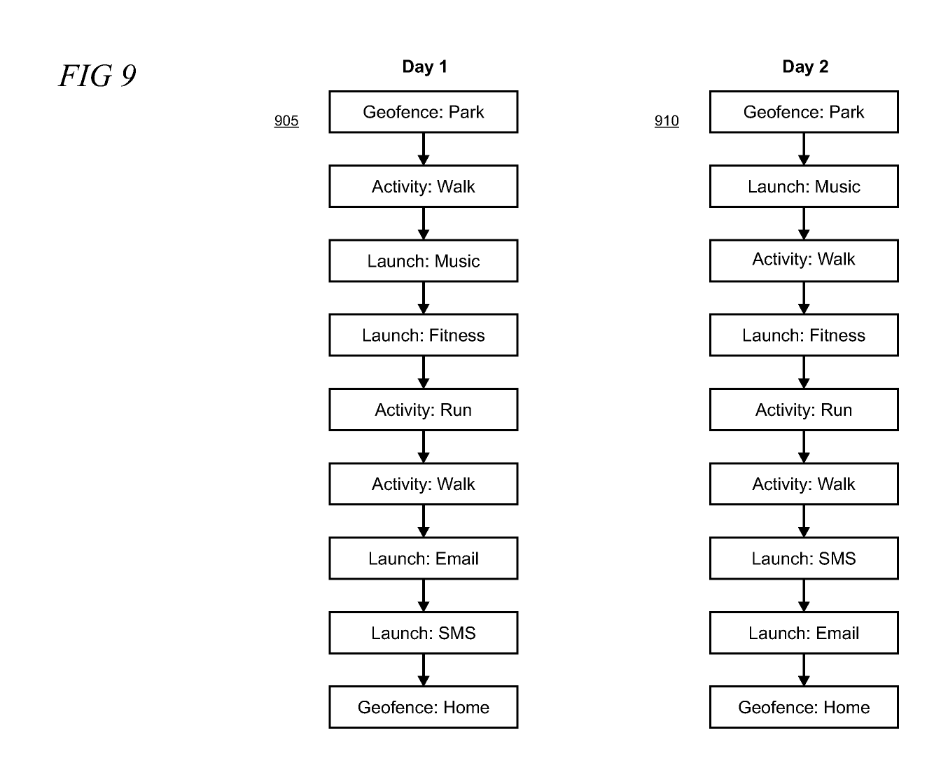

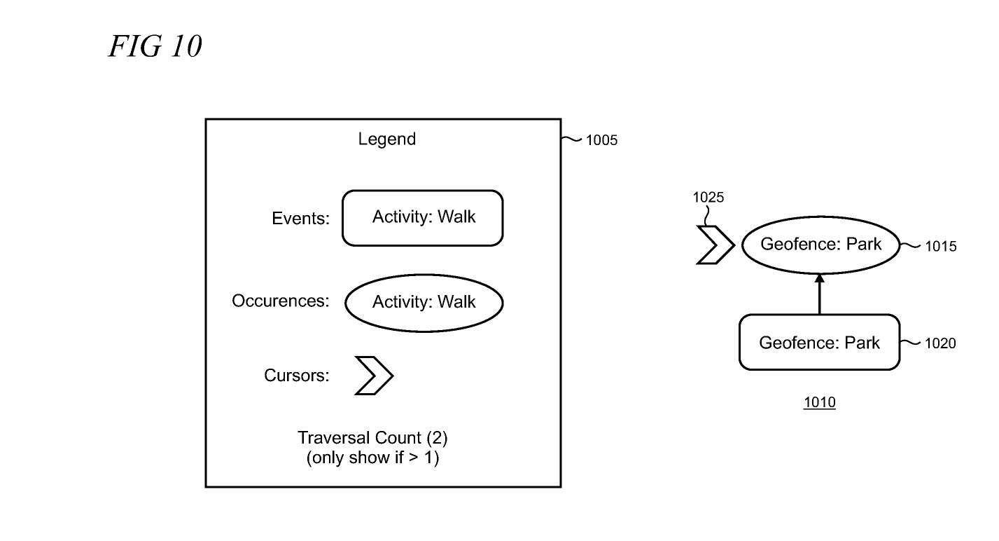

The operation of the behavioral learning engine 815 is described next in an illustrative scenario. As shown in FIG. 9, a sequence of events occurs on each of two days, as respectively indicated by reference numerals 905 and 910. Trees are constructed by the engine using a consistent convention as shown in the legend 1005 in FIG. 10 in which events (shown using a rounded rectangle) represent a specific type of event and there is only one instance per event type. Occurrences (shown using an oval) represent incidents of an event type occurring and there can be many occurrences for a single type of event. Cursors point to occurrences in the tree structure. They are utilized to traverse (i.e., walk) the trees and add them, as needed, as events occur. Accordingly, if the occurrence trees represent knowledge, then the cursors represent state.

The first event in this illustrative scenario is derived from a geofence signal indicating arrival at a park as shown in tree 1010 in FIG. 10. The behavioral learning engine has no pre-knowledge of event types and they are presented as strings which are associated via a map with event objects. Any time an event is presented for processing, the map is consulted for an existing event object before a new one is created. With this approach, the engine can accommodate new kinds of events at any time without modification.

Each event object stores the root of a tree of occurrences. So when the first geofence event is processed, a new occurrence tree root 1015 is created along with the new event object 1020. Also, a cursor 1025 is allocated to point to the root of the tree 1015, as shown.

The next event in the illustrative scenario is derived from an activity recognition signal for walking. Similar to the previous event, a new walking event is created, along with an associated tree root and cursor. Any time an event is processed, all existing cursors are updated as well. In this case, only one previous cursor was created from the geofence event. Cursors are updated by traversing the trees they are in. Since there is no walking occurrence attached to the geofence occurrence, one is created and the cursor is advanced. The state of the system now appears as shown by the trees in FIG. 11 (collectively indicated using reference numeral 1100).

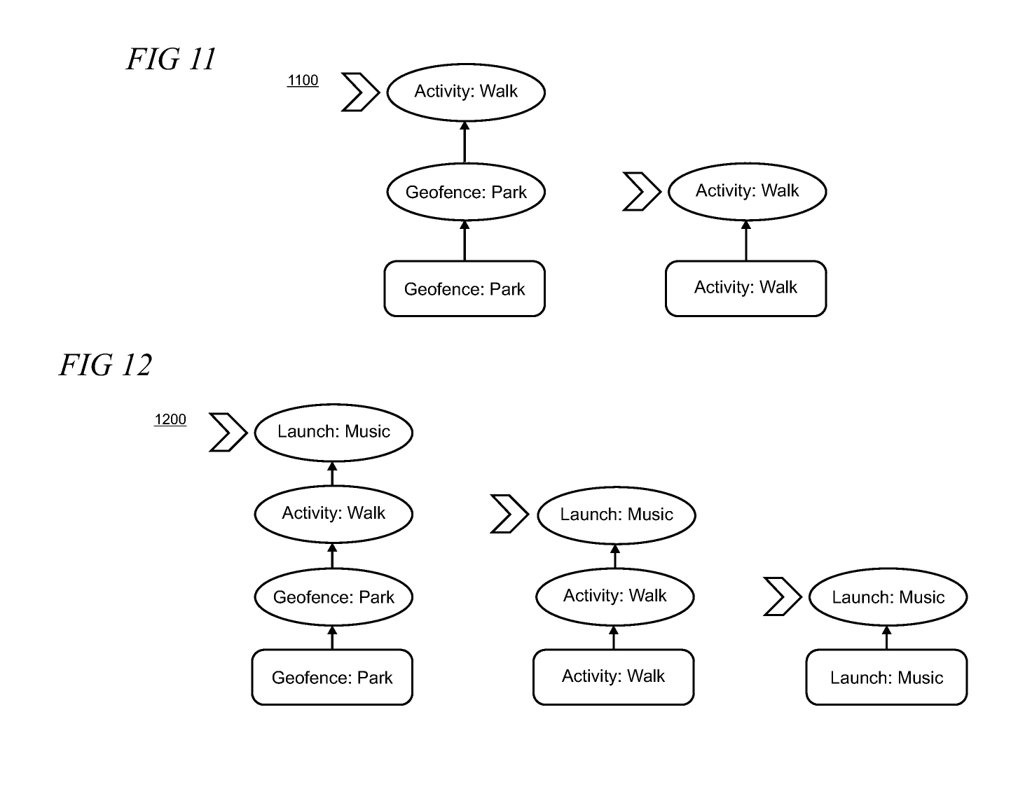

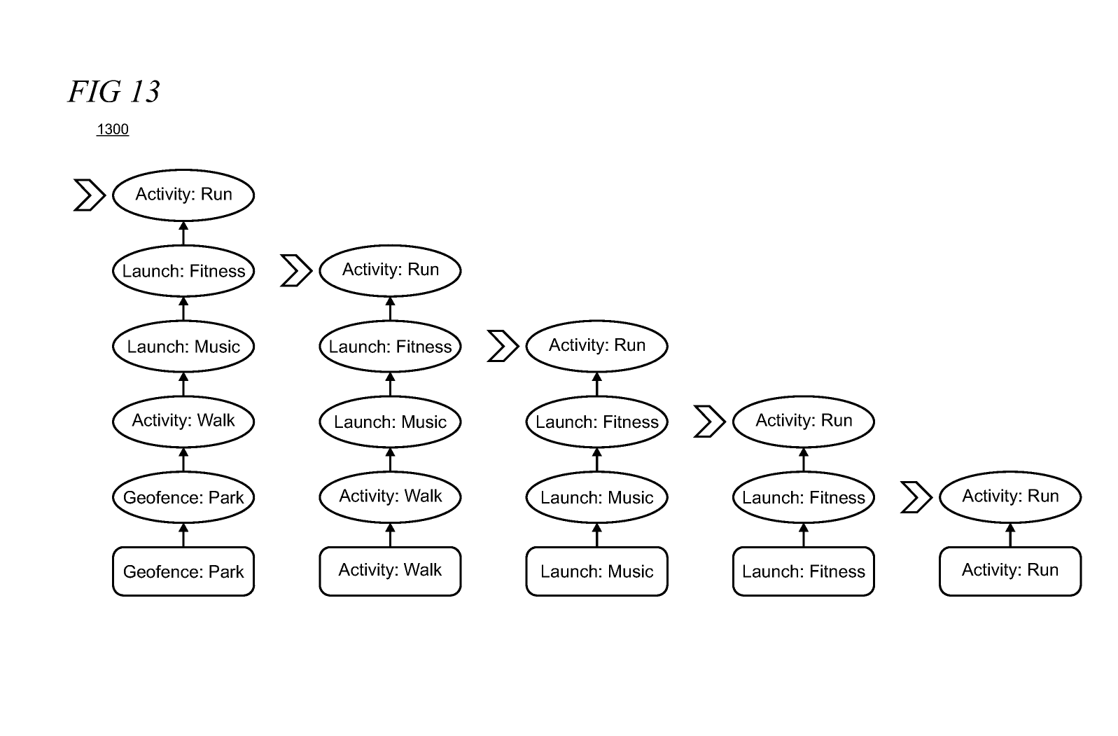

The pattern is repeated when the music player launch signal is received. The state of the system is shown by the trees 1200 in FIG. 12. After processing the run event similarly, the system is shown by the trees 1300 in FIG. 13.

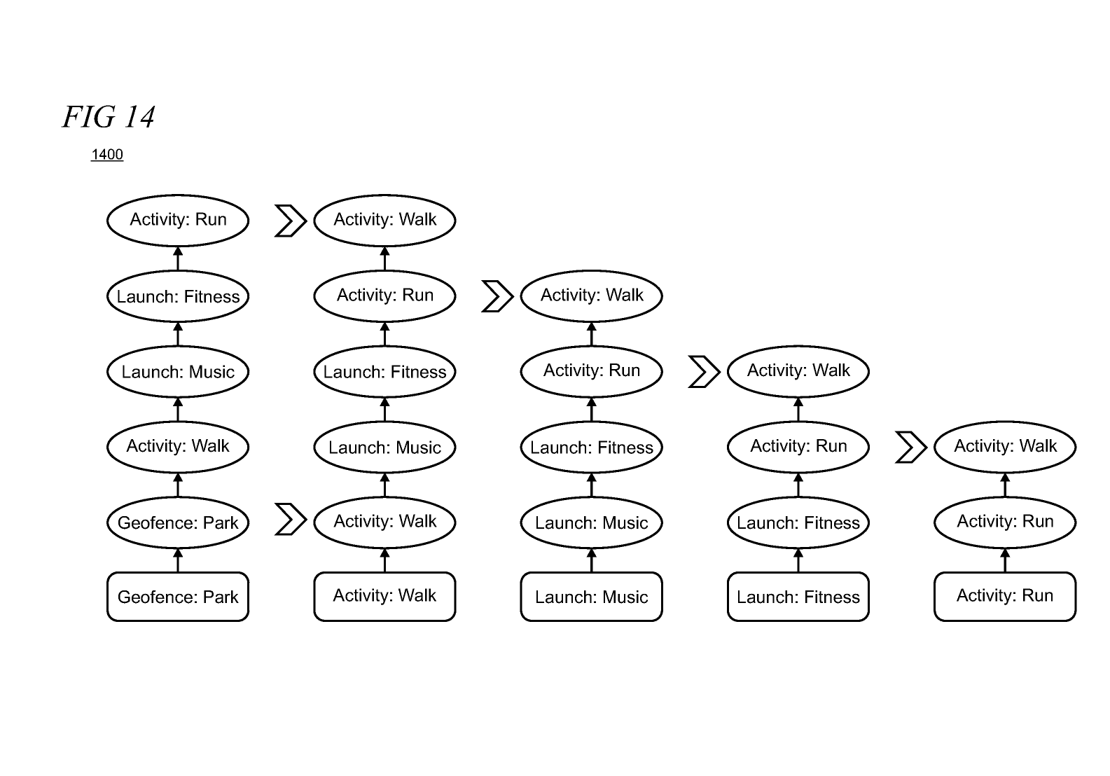

The next event processed is another walk event. Because there is already a walk event object, a new one is not created. However, a new cursor is still created to point to the root occurrence in that tree. It is noted that there is also another cursor already traversing that tree which is updated by expanding the tree as before. At this point, it may be expected that the geofence event tree would be expanded by another walk occurrence, but the behavior learning engine limits tree depth to an arbitrary five levels in this particular example. Having reached this limit, the cursor in the geofence tree is discarded. The remaining trees are expanded as previously seen. The system state is shown by the trees 1400 in FIG. 14.

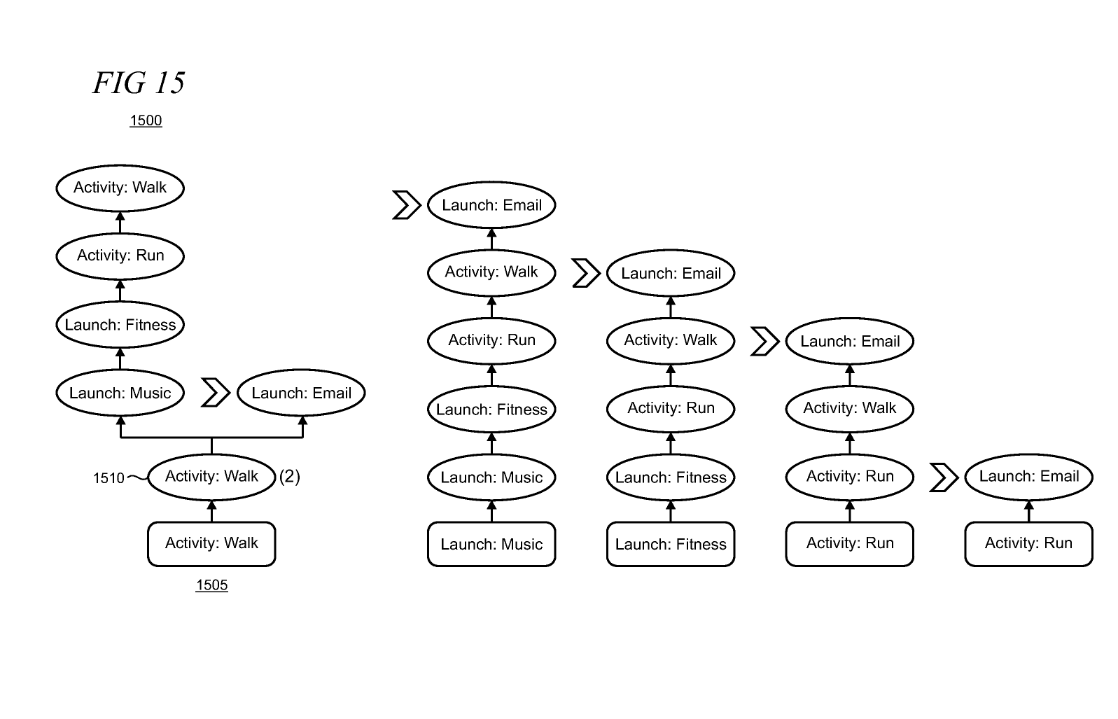

The next signal received indicates that an email application was launched. Most of the trees are updated as before as shown by the trees 1500 in FIG. 15, and for the first time, a split occurs in the walk tree 1505. Note that the “(2)” next to the walk activity 1510 indicates that it was traversed twice.

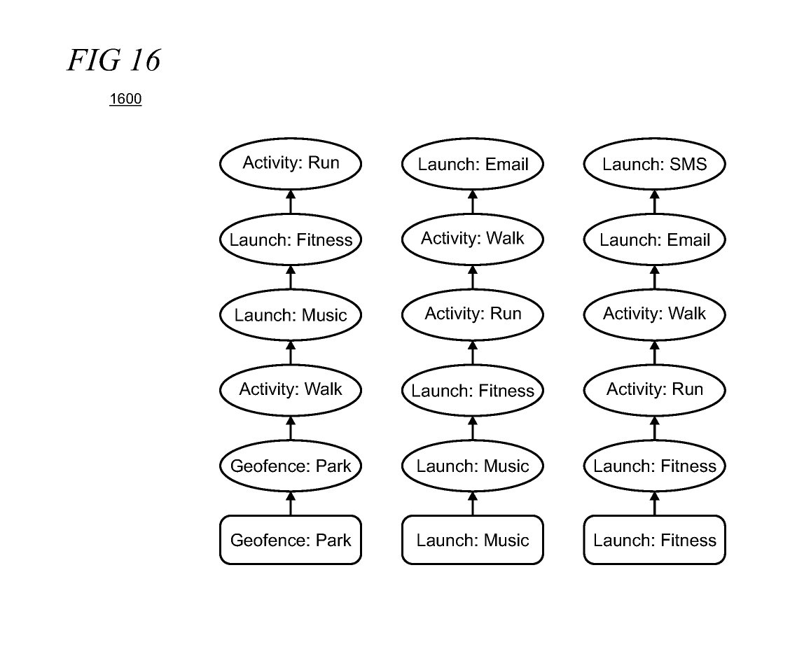

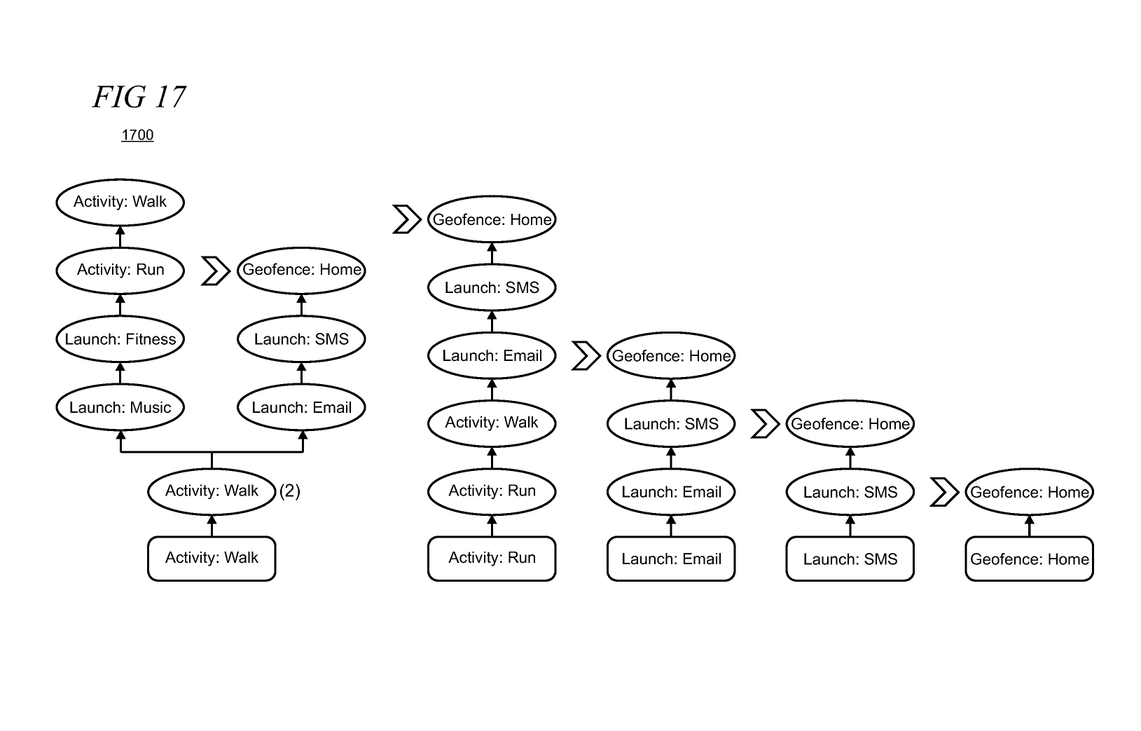

When the remaining events for Day 1 are processed, the system (including trees without active cursors) is as shown by the trees 1600 and 1700 respectively in FIGS. 16 and 17.

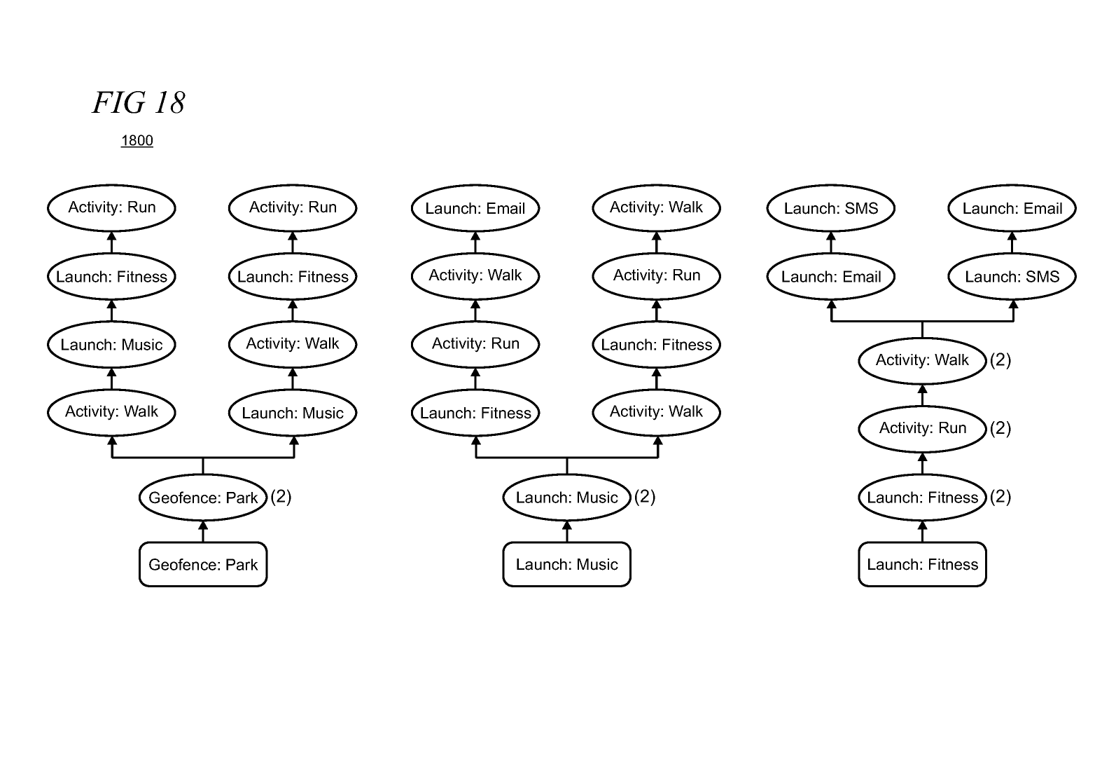

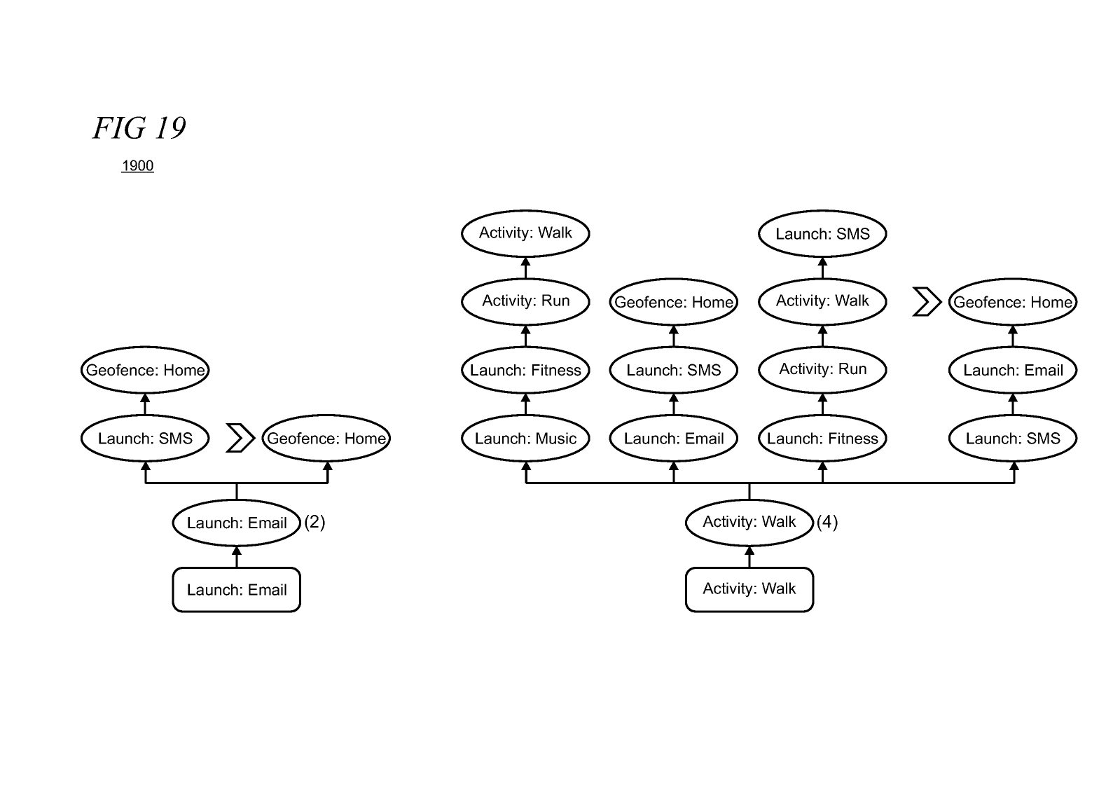

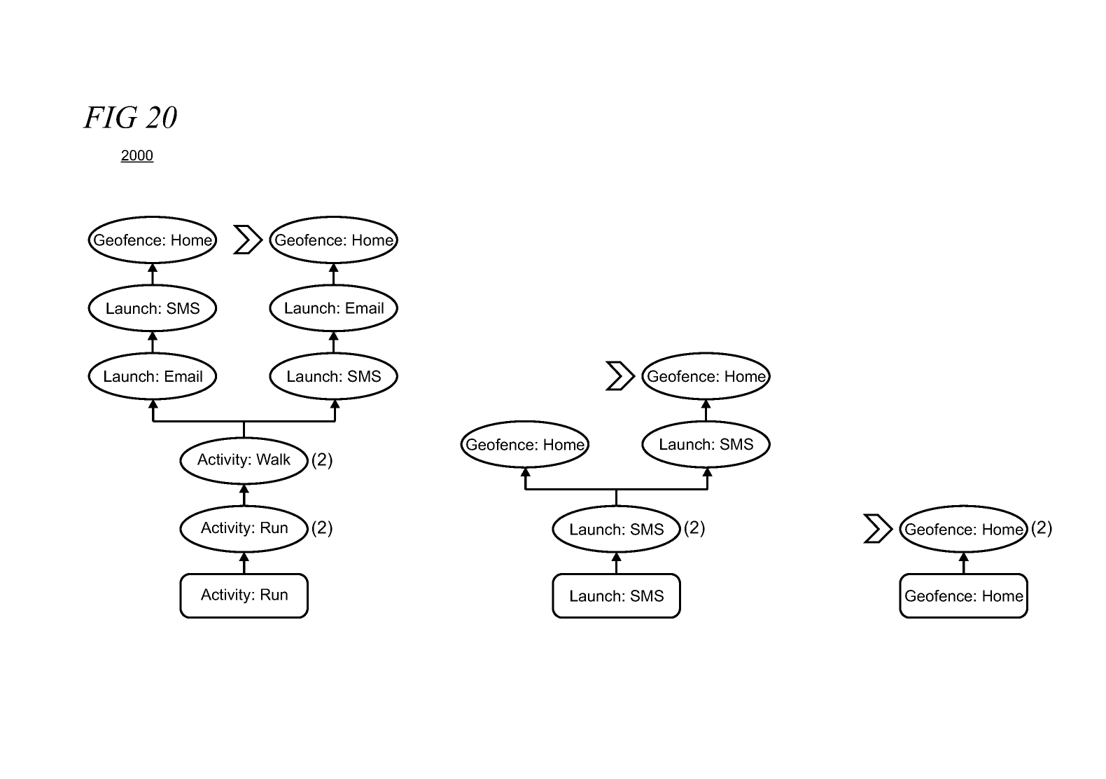

The Day 2 events are similar to Day 1, but this time the user launches music before starting to walk, and happens to check SMS (Short Message Service) messages before checking email. Incorporating these events into the tree structures results in the arrangement shown by the trees 1800, 1900, and 2000, respectively in FIGS. 18, 19, and 20.

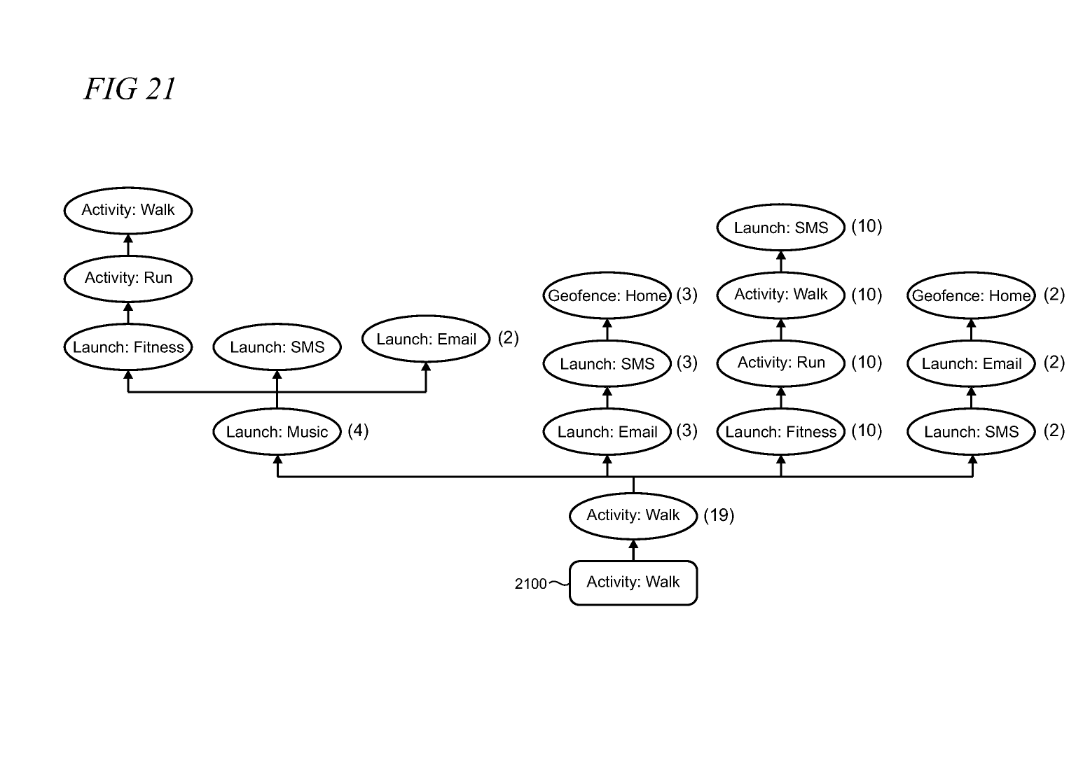

As events are processed over time, the trees can become complex. The traversal count provides a mechanism by which predictions may be made given the current state of the system. For example, consider the tree stemming from a walk event 2100 in FIG. 21. Without knowing any previous events that occurred before it, when examining the traversals, the tree suggests that after a walk event the odds are four out of nineteen that the user will launch a music application. The most likely thing the user will do, though, is launch the fitness application based on odds of ten out of nineteen. If previous events are taken into consideration, then certainty about what the user may do next will increase. For example, if the user walks, launches music, and launches a fitness application, he/she will likely go for a run. According to the tree, it is the only thing the user has ever done under those circumstances. However, the user only did it once before, so even though probability is one hundred percent, confidence is low. Accordingly, prediction confidence increases as probability and traversal count increases. For example, a suggestion is not made to the user to launch an application unless the traversal count is at least three with probability being greater than fifty percent. If the user agrees to the suggestion, then the signal chain is reinforced. If the user declines, then the signal chain may be reinforced either positively or negatively depending on what the user does next.

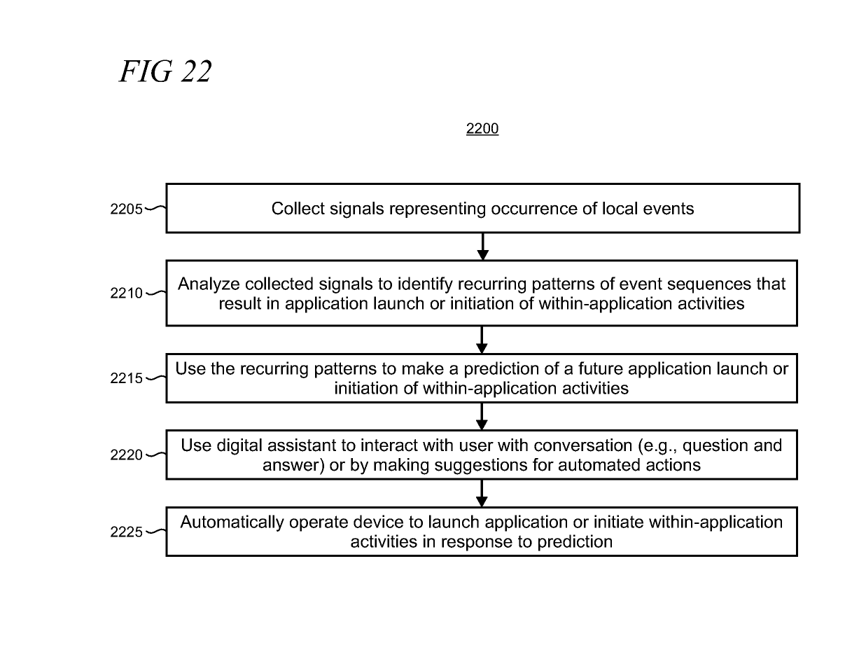

FIG. 22 shows a flowchart of an illustrative method 2200 that may be performed on a mobile device comprising a processor, a UI, and a memory device. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 2205, signals are collected that represent occurrence of local events on the device. “Local” events are those relating to activities which are local to the device such as activity recognition, a user plugging in or removing earbuds, changes in WiFi network connection status, previous application launches, or the like. In some cases, the signals can be collected, in whole or part, from an interface to a digital assistant which may be configured to monitor events as part of its native functionality. The OS on the mobile device may also be utilized in some cases to provide suitable local signals. In step 2210, the collected signals are analyzed to identify recurring patterns of sequences of events that result in an application launch or an initiation of within-application activities (e.g., browsing and launching a playlist from within a music player application).

In step 2215, the identified recurring patterns are used to make a prediction of a future application launch or a future initiation of a within-application activity. For example, a user may regularly engage in an exercise routine that involves driving to the gym, starting a music application, starting a fitness application, performing the workout, and then stopping the applications. Such recurring pattern of activities is identified so that the mobile device can, for example, automatically launch the applications the next time the user drives to the gym. The identification of recurring patterns may be variously performed using the tree structures described above, or one of Bayesian network, neural network, regression, or classification depending on the particular implementation. The predictions may be based on probability and utilize a measure of confidence that may be calculated by tracking a frequency of event occurrence.

In step 2220, the digital assistant may be utilized to interact with the device user such as by participating in conversations and making suggestions for automated actions that can be taken. In step 2225, the mobile device is automatically operated in response to the prediction to launch an application or initiate within-application activities.

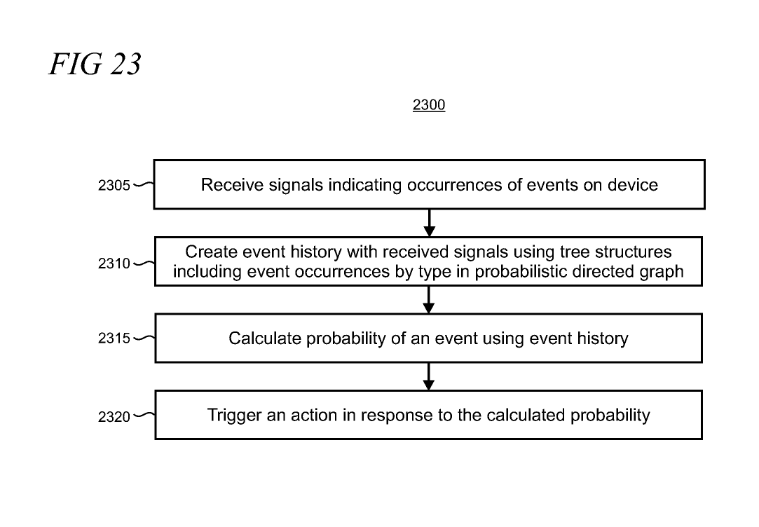

FIG. 23 shows a flowchart of an illustrative method 2300 that may be performed by executing instructions stored on a computer-readable memory by one or more processors on a device. In step 2305, signals are received that represent occurrence of events on the electronic device. In step 2310, an event history is created using the received signals in which tree structures including event occurrences by type are populated into a probabilistic directed graph. In step 2315, the event history is used to calculate a probability of an event (i.e., a future event occurrence). Event occurrence in the tree structures may be counted to generate a confidence level in the calculated probability. In step 2320, an action is triggered responsively to the calculated probability. The action may include, for example, launching an application or initiating a within-application activity. In some cases, prior to triggering an action, a UI can be employed to make a request to the user for a confirmation. The request can take the form of a question and answer interaction between the device and the user or be implemented as a suggestion. User response to the request may be used as feedback to enable the tree structures in the event history to be updated.

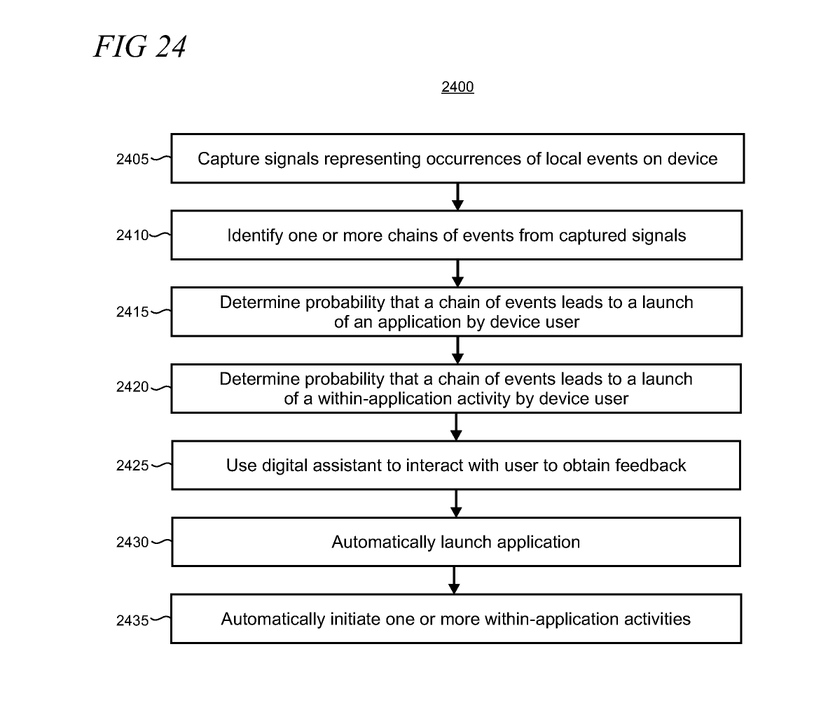

FIG. 24 shows a flowchart of an illustrative method 2400 that may be performed on a device. In step 2405, signals representing occurrences of events that are local to the device are captured over some time interval. One or more chains of events are identified from the captured signals in step 2410. In step 2415, a probability that a given chain of events leads to a launch of an application is determined In step 2420, a level of confidence in the probability is determined In step 2425, a digital assistant on the device is utilized to interact with the device user to obtain feedback which may include requesting a confirmation prior to taking an action such as an automated launch or initiation. In step 2430, an application is automatically launched when the determined probability exceeds a predetermined probability threshold and the determined confidence level exceeds a predetermined confidence threshold. In step 2435, one or more within-application activities are automatically initiated based on a determination of a probability that a chain of events leads to an initiation of a within-application activity.

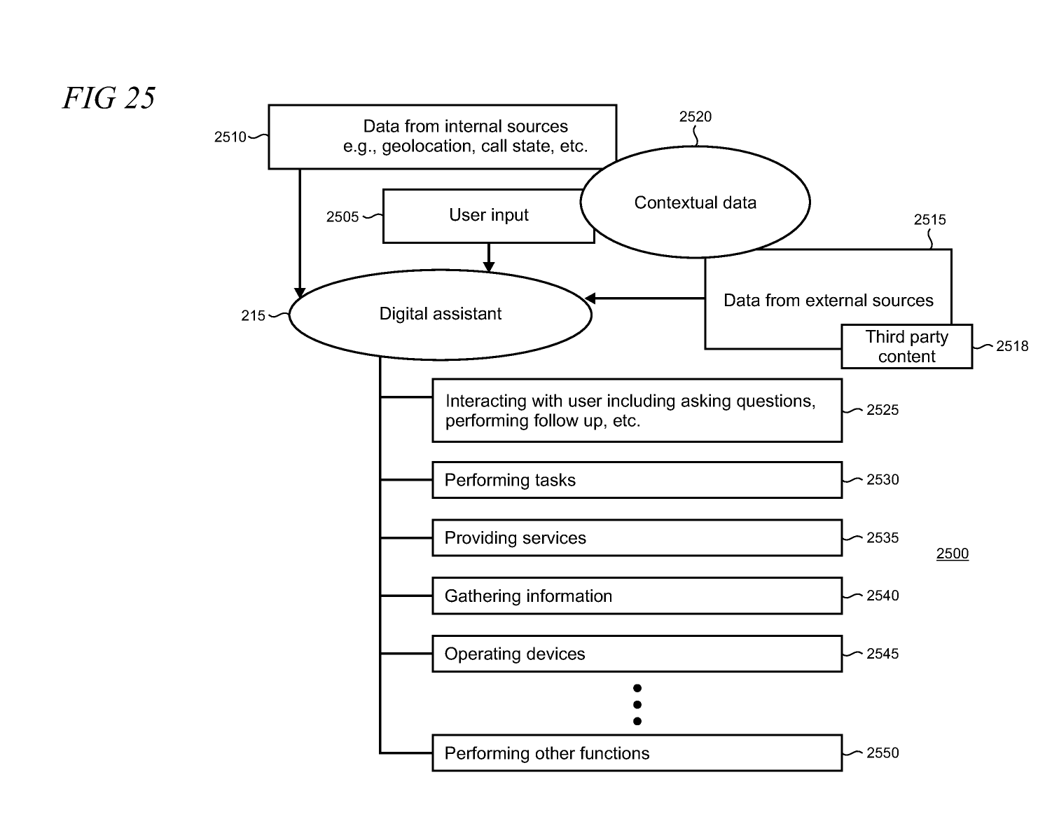

Various implementation details of the present behavior recognition and automation are now presented. FIG. 25 shows an illustrative taxonomy of functions 2500 that may typically be supported by the digital assistant 215. Inputs to the digital assistant typically can include user input 2505, data from internal sources 2510, and data from external sources 2515 which can include third-party content 2518. For example, data from internal sources 2510 could include the current location of the device 110 that is reported by a GPS (Global Positioning System) component on the device, or some other location-aware component. The externally sourced data 2515 includes data provided, for example, by external systems, databases, services, and the like such as the content provider 125 and/or service provider 130 (FIG. 1).

The various inputs can be used alone or in various combinations to enable the digital assistant to utilize contextual data 2520 when it operates. Contextual data can include, for example, time/date, the user's location, language, schedule, applications installed on the device, the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, communication network type and/or features/functionalities provided therein, mobile data plan restrictions/limitations, data associated with other parties to a communication (e.g., their schedules, preferences, etc.), and the like.

As shown, the functions 2500 illustratively include interacting with the user 2525 (through a natural language UI, a voice-based UI, or a graphical UI, for example); performing tasks 2530 (e.g., making note of appointments in the user's calendar, sending messages and emails, etc.); providing services 2535 (e.g., answering questions from the user, mapping directions to a destination, setting alarms, forwarding notifications, etc.); gathering information 2540 (e.g., finding information requested by the user about a book or movie, locating the nearest Italian restaurant, etc.); operating devices 2545 (e.g., setting preferences, adjusting screen brightness, turning wireless connections such as Wi-Fi and Bluetooth on and off, communicating with other devices, controlling smart appliances, etc.); and performing various other functions 2550. The list of functions 2500 is not intended to be exhaustive and other functions may be provided by the digital assistant as may be needed for a particular implementation of the present behavior recognition and automation.

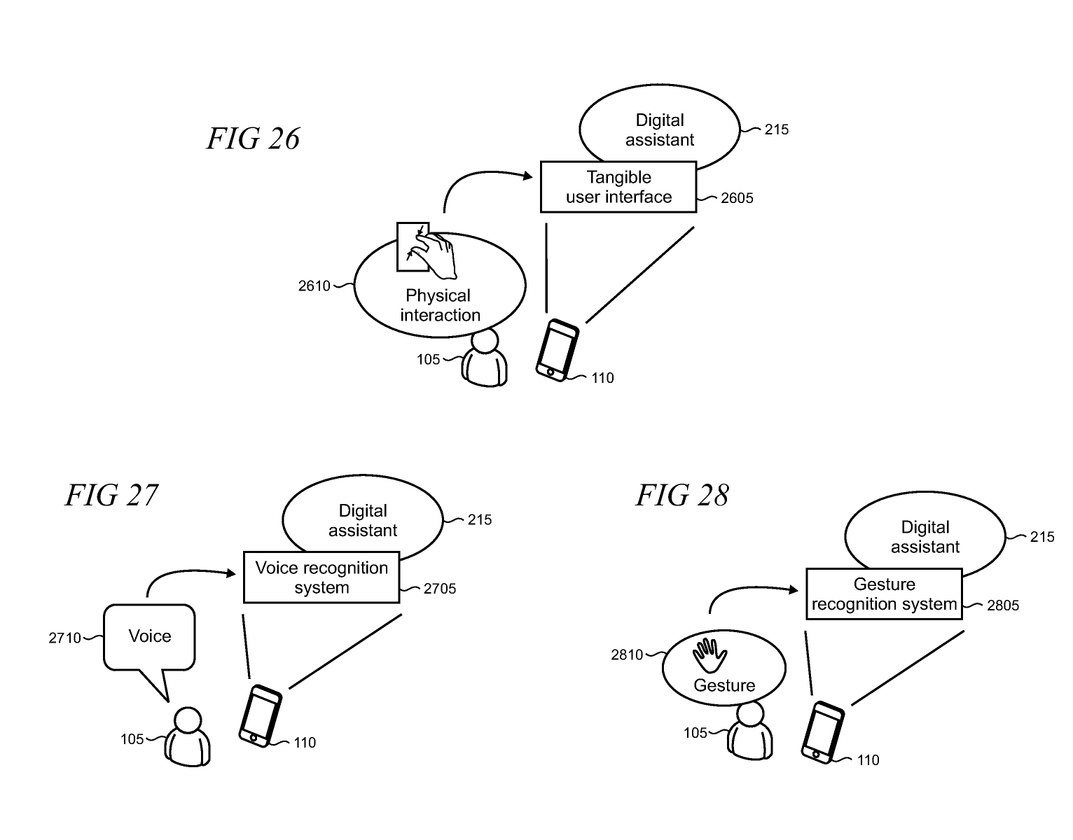

A user can typically interact with the digital assistant 215 in a number of ways depending on the features and functionalities supported by a given device 110. For example, as shown in FIG. 26, the digital assistant 215 may expose a tangible user interface 2605 that enables the user 105 to employ physical interactions 2610 in support of the experiences, features, and functions on the device 110. Such physical interactions can include manipulation of physical and/or virtual controls such as buttons, menus, keyboards, etc., using touch-based inputs like tapping, flicking, dragging, etc. on a touch screen, and the like.

As shown in FIG. 27, the digital assistant 215 can employ a voice recognition system 2705 having a UI that can take voice inputs 2710 from the user 105. The voice inputs 2710 can be used to invoke various actions, features, and functions on a device 110, provide inputs to the systems and applications, and the like. In some cases, the voice inputs 2710 can be utilized on their own in support of a particular user experience while in other cases the voice input can be utilized in combination with other non-voice inputs or inputs such as those implementing physical controls on the device or virtual controls implemented on a UI or those using gestures (as described below).

The digital assistant 215 can also employ a gesture recognition system 2805 having a UI as shown in FIG. 28. Here, the system 2805 can sense gestures 2810 performed by the user 105 as inputs to invoke various actions, features, and functions on a device 110, provide inputs to the systems and applications, and the like. The user gestures 2810 can be sensed using various techniques such as optical sensing, touch sensing, proximity sensing, and the like. In some cases, various combinations of voice commands, gestures, and physical manipulation of real or virtual controls can be utilized to interact with the digital assistant. In some scenarios, the digital assistant can be automatically invoked and/or be adapted to operate responsively to biometric data or environmental data.

Accordingly, as the digital assistant typically maintains awareness of device state and other context, it may be invoked or controlled by specific context such as user input, received notifications, or detected events associated with biometric or environmental data. For example, the digital assistant can behave in particular ways and surface appropriate user experiences when biometric and environmental data indicates that the user is active and moving around outdoors as compared to occasions when the user is sitting quietly inside. If the user seems stressed or harried, the digital assistant might suggest music selections that are relaxing and calming When data indicates that the user has fallen asleep for a nap, the digital assistant can mute device audio, set a wakeup alarm, and indicate the user's online status as busy.

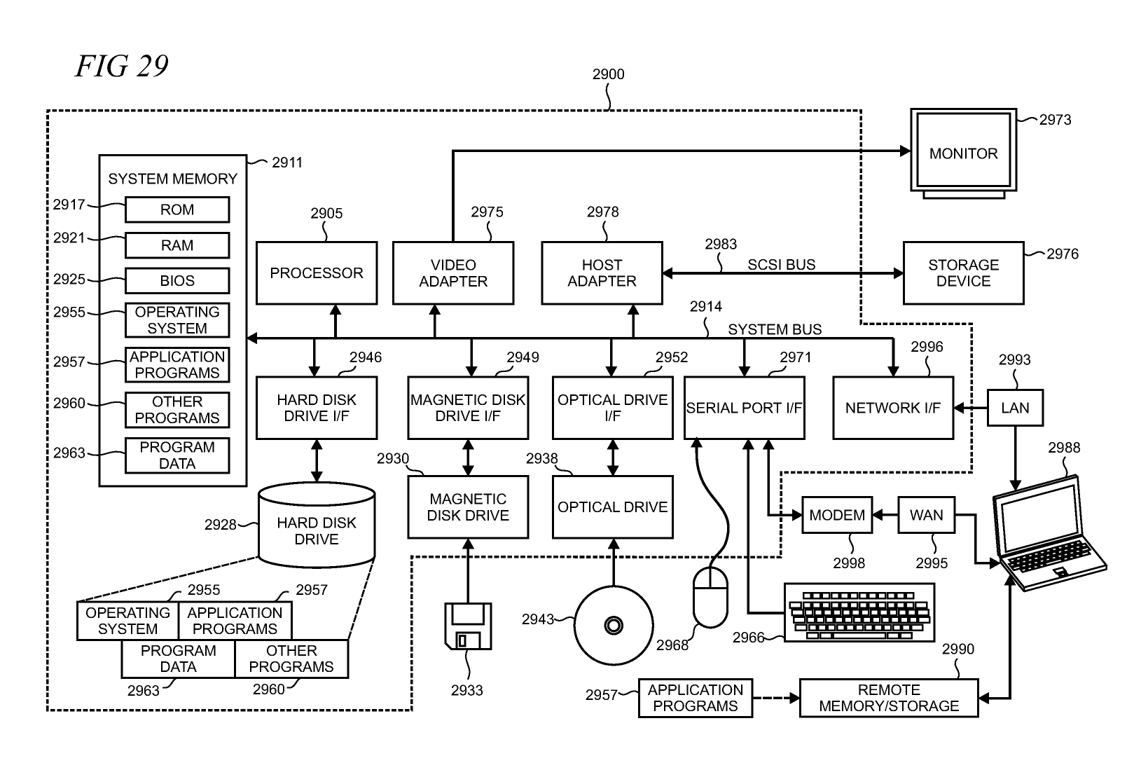

FIG. 29 is a simplified block diagram of an illustrative computer system 2900 such as a PC, client machine, or server with which the present digital assistant alarm system may be implemented. Computer system 2900 includes a processor 2905, a system memory 2911, and a system bus 2914 that couples various system components including the system memory 2911 to the processor 2905. The system bus 2914 may be any of several types of bus structures including a memory bus or memory controller, a peripheral bus, or a local bus using any of a variety of bus architectures. The system memory 2911 includes read only memory (ROM) 2917 and random access memory (RAM) 2921. A basic input/output system (BIOS) 2925, containing the basic routines that help to transfer information between elements within the computer system 2900, such as during startup, is stored in ROM 2917. The computer system 2900 may further include a hard disk drive 2928 for reading from and writing to an internally disposed hard disk (not shown), a magnetic disk drive 2930 for reading from or writing to a removable magnetic disk 2933 (e.g., a floppy disk), and an optical disk drive 2938 for reading from or writing to a removable optical disk 2943 such as a CD (compact disc), DVD (digital versatile disc), or other optical media. The hard disk drive 2928, magnetic disk drive 2930, and optical disk drive 2938 are connected to the system bus 2914 by a hard disk drive interface 2946, a magnetic disk drive interface 2949, and an optical drive interface 2952, respectively. The drives and their associated computer-readable storage media provide non-volatile storage of computer-readable instructions, data structures, program modules, and other data for the computer system 2900. Although this illustrative example includes a hard disk, a removable magnetic disk 2933, and a removable optical disk 2943, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present digital assistant alarm system. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2933, optical disk 2943, ROM 2917, or RAM 2921, including an operating system 2955, one or more application programs 2957, other program modules 2960, and program data 2963. A user may enter commands and information into the computer system 2900 through input devices such as a keyboard 2966 and pointing device 2968 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 2905 through a serial port interface 2971 that is coupled to the system bus 2914, but may be connected by other interfaces, such as a parallel port, game port, or universal serial bus (USB). A monitor 2973 or other type of display device is also connected to the system bus 2914 via an interface, such as a video adapter 2975. In addition to the monitor 2973, personal computers typically include other peripheral output devices (not shown), such as speakers and printers. The illustrative example shown in FIG. 29 also includes a host adapter 2978, a Small Computer System Interface (SCSI) bus 2983, and an external storage device 2976 connected to the SCSI bus 2983.

The computer system 2900 is operable in a networked environment using logical connections to one or more remote computers, such as a remote computer 2988. The remote computer 2988 may be selected as another personal computer, a server, a router, a network PC, a peer device, or other common network node, and typically includes many or all of the elements described above relative to the computer system 2900, although only a single representative remote memory/storage device 2990 is shown in FIG. 29. The logical connections depicted in FIG. 29 include a local area network (LAN) 2993 and a wide area network (WAN) 2995. Such networking environments are often deployed, for example, in offices, enterprise-wide computer networks, intranets, and the Internet.

When used in a LAN networking environment, the computer system 2900 is connected to the local area network 2993 through a network interface or adapter 2996. When used in a WAN networking environment, the computer system 2900 typically includes a broadband modem 2998, network gateway, or other means for establishing communications over the wide area network 2995, such as the Internet. The broadband modem 2998, which may be internal or external, is connected to the system bus 2914 via a serial port interface 2971. In a networked environment, program modules related to the computer system 2900, or portions thereof, may be stored in the remote memory storage device 2990. It is noted that the network connections shown in FIG. 29 are illustrative and other means of establishing a communications link between the computers may be used depending on the specific requirements of an application of the present digital assistant alarm system.

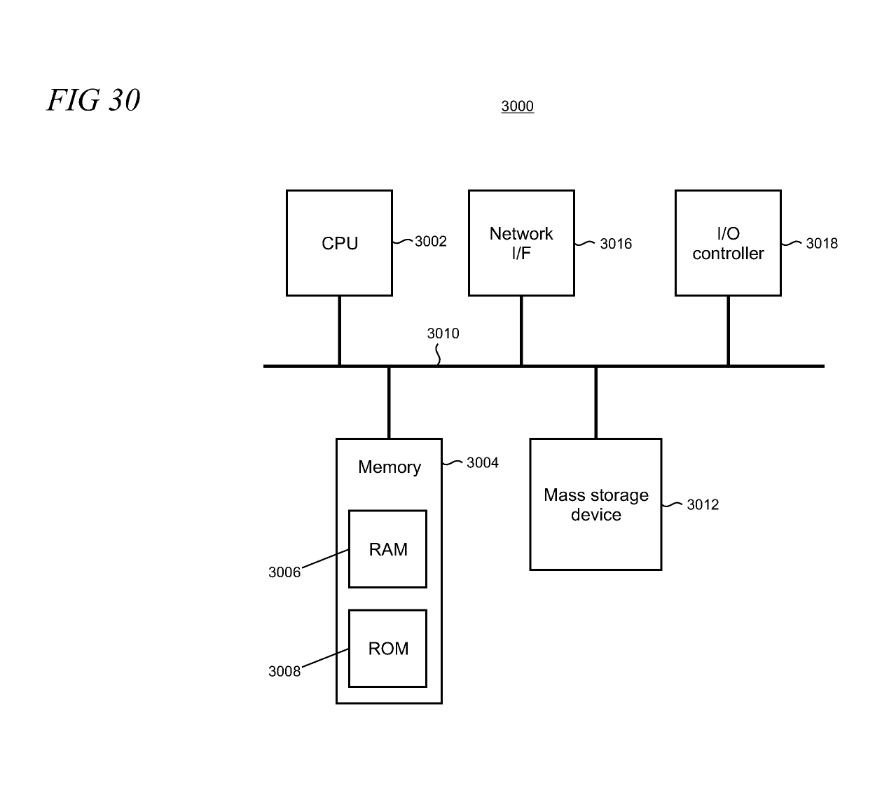

FIG. 30 shows an illustrative architecture 3000 for a device capable of executing the various components described herein for providing the present digital assistant alarm system. Thus, the architecture 3000 illustrated in FIG. 30 shows an architecture that may be adapted for a server computer, mobile phone, a PDA, a smartphone, a desktop computer, a netbook computer, a tablet computer, GPS device, gaming console, and/or a laptop computer. The architecture 3000 may be utilized to execute any aspect of the components presented herein.

The architecture 3000 illustrated in FIG. 30 includes a CPU (Central Processing Unit) 3002, a system memory 3004, including a RAM 3006 and a ROM 3008, and a system bus 3010 that couples the memory 3004 to the CPU 3002. A basic input/output system containing the basic routines that help to transfer information between elements within the architecture 3000, such as during startup, is stored in the ROM 3008. The architecture 3000 further includes a mass storage device 3012 for storing software code or other computer-executed code that is utilized to implement applications, the file system, and the operating system.

The mass storage device 3012 is connected to the CPU 3002 through a mass storage controller (not shown) connected to the bus 3010.The mass storage device 3012 and its associated computer-readable storage media provide non-volatile storage for the architecture 3000.

Although the description of computer-readable storage media contained herein refers to a mass storage device, such as a hard disk or CD-ROM drive, it should be appreciated by those skilled in the art that computer-readable storage media can be any available storage media that can be accessed by the architecture 3000.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 3000.

According to various embodiments, the architecture 3000 may operate in a networked environment using logical connections to remote computers through a network. The architecture 3000 may connect to the network through a network interface unit 3016 connected to the bus 3010. It should be appreciated that the network interface unit 3016 also may be utilized to connect to other types of networks and remote computer systems. The architecture 3000 also may include an input/output controller 3018 for receiving and processing input from a number of other devices, including a keyboard, mouse, or electronic stylus (not shown in FIG. 30). Similarly, the input/output controller 3018 may provide output to a display screen, a printer, or other type of output device (also not shown in FIG. 30).

It should be appreciated that the software components described herein may, when loaded into the CPU 3002 and executed, transform the CPU 3002 and the overall architecture 3000 from a general-purpose computing system into a special-purpose computing system customized to facilitate the functionality presented herein. The CPU 3002 may be constructed from any number of transistors or other discrete circuit elements, which may individually or collectively assume any number of states. More specifically, the CPU 3002 may operate as a finite-state machine, in response to executable instructions contained within the software modules disclosed herein. These computer-executable instructions may transform the CPU 3002 by specifying how the CPU 3002 transitions between states, thereby transforming the transistors or other discrete hardware elements constituting the CPU 3002.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 3000 in order to store and execute the software components presented herein. It also should be appreciated that the architecture 3000 may include other types of computing devices, including handheld computers, embedded computer systems, smartphones, PDAs, and other types of computing devices known to those skilled in the art. It is also contemplated that the architecture 3000 may not include all of the components shown in FIG. 30, may include other components that are not explicitly shown in FIG. 30, or may utilize an architecture completely different from that shown in FIG. 30.

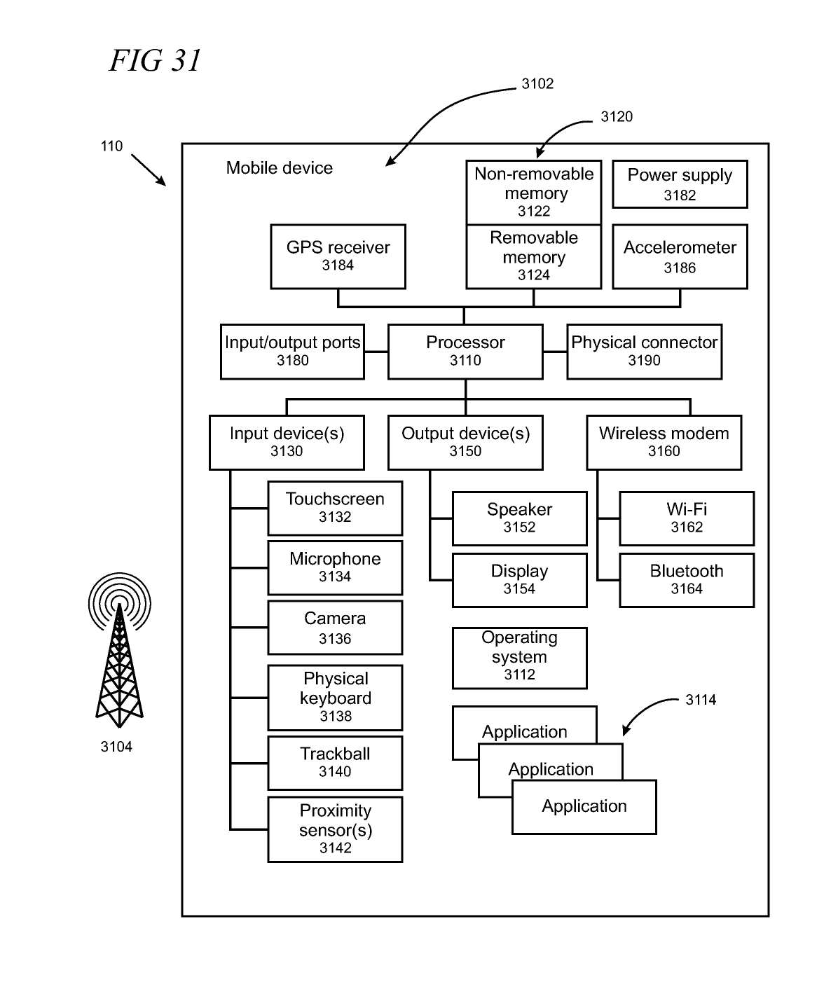

FIG. 31 is a functional block diagram of an illustrative device 110 such as a mobile phone or smartphone including a variety of optional hardware and software components, shown generally at 3102. Any component 3102 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 3104, such as a cellular or satellite network.

The illustrated device 110 can include a controller or processor 3110 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 3112 can control the allocation and usage of the components 3102, including power states, above-lock states, and below-lock states, and provides support for one or more application programs 3114. The application programs can include common mobile computing applications (e.g., image-capture applications, email applications, calendars, contact managers, web browsers, messaging applications), or any other computing application.

The illustrated device 110 can include memory 3120. Memory 3120 can include non-removable memory 3122 and/or removable memory 3124. The non-removable memory 3122 can include RAM, ROM, Flash memory, a hard disk, or other well-known memory storage technologies. The removable memory 3124 can include Flash memory or a Subscriber Identity Module (SIM) card, which is well known in GSM (Global System for Mobile communications) systems, or other well-known memory storage technologies, such as “smart cards.” The memory 3120 can be used for storing data and/or code for running the operating system 3112 and the application programs 3114. Example data can include web pages, text, images, sound files, video data, or other data sets to be sent to and/or received from one or more network servers or other devices via one or more wired or wireless networks.

The memory 3120 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 110.

The memory 3120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 110 can support one or more input devices 3130; such as a touch screen 3132; microphone 3134 for implementation of voice input for voice recognition, voice commands and the like; camera 3136; physical keyboard 3138; trackball 3140; and/or proximity sensor 3142; and one or more output devices 3150, such as a speaker 3152 and one or more displays 3154. Other input devices (not shown) using gesture recognition may also be utilized in some cases. Other possible output devices (not shown) can include piezoelectric or haptic output devices. Some devices can serve more than one input/output function. For example, touchscreen 3132 and display 3154 can be combined into a single input/output device.

A wireless modem 3160 can be coupled to an antenna (not shown) and can support two-way communications between the processor 3110 and external devices, as is well understood in the art. The modem 3160 is shown generically and can include a cellular modem for communicating with the mobile communication network 3104 and/or other radio-based modems (e.g., Bluetooth 3164 or Wi-Fi 3162). The wireless modem 3160 is typically configured for communication with one or more cellular networks, such as a GSM network for data and voice communications within a single cellular network, between cellular networks, or between the device and a public switched telephone network (PSTN).

The device can further include at least one input/output port 3180, a power supply 3182, a satellite navigation system receiver 3184, such as a GPS receiver, an accelerometer 3186, a gyroscope (not shown), and/or a physical connector 3190, which can be a USB port, IEEE 1394 (FireWire) port, and/or an RS-232 port. The illustrated components 3102 are not required or all-inclusive, as any components can be deleted and other components can be added.

Various exemplary embodiments of the present behavior recognition and automation using a mobile device are now presented by way of illustration and not as an exhaustive list of all embodiments. An example includes a mobile device, comprising: one or more processors; a user interface (UI) configured to interact with a user of the device using one of visual display or audio; and a memory device storing computer-readable instructions which, when executed by the one or more processors, perform an automated method for launching applications or initiating within-application activities, comprising: collecting signals representing events that are occurring locally on the device, analyzing the collected signals to identify recurring patterns of sequences of events that result in an application launch or an initiation of one or more within-application activities, using the recurring patterns to make a prediction of a future application launch or a future initiation of one or more within-application activities, and automatically operating the device to launch an application or initiating one or more within-application activities responsively to the prediction.

In another example, the mobile device further includes collecting at least a portion of the signals from a digital assistant that is supported on the device in which the digital assistant interacts with the user through the UI. In another example, the mobile device further includes performing the analyzing using one of Bayesian network, neural network, regression, or classification. In another example, the events include one or more of application launch events initiated by the user, within-application activity events initiated by the user, activity events including idle, stationary, walking, or running, driving events including vehicle telemetry, audio routing events including using an audio endpoint, geofence boundary crossing events, wireless network connection or disconnection events, short range network connection or disconnection events, battery charge state events, charger connection or disconnection events, alarm creation events, alarm deletion events, or lock state events. In another example, the mobile device further includes tracking a frequency of occurrences of events and launching the application or initiating the within-application activities responsively at least in part to the tracked frequency. In another example, the mobile device further includes using a digital assistant to support interactions with the user including participating in conversations and making suggestions for automated actions.

A further example includes one or more computer-readable memories storing instructions which, when executed by one or more processors disposed in a device, implement a machine learning system adapted for: receiving signals that are indicative of occurrences of events on the device; creating an event history using the received signals, in which event history is represented using one or more tree structures including event occurrences by type that are populated into a probabilistic directed graph; calculating a probability of an event using the event history; and triggering an action responsively to the calculated probability.

In another example, the one or more computer-readable memories further includes counting event occurrences in the one or more tree structures to generate a confidence level for the event probability and triggering the action, at least in part, responsively to confidence level. In another example, the one or more the action includes an automated application launch or an automated initiation of a within-application activity. In another example, the one or more computer-readable memories further include making a request to a device user for confirmation of the action prior to the triggering. In another example, the one or more computer-readable memories further include triggering a suggestion for an action and exposing the suggestion through a user interface to a device user. In another example, the one or more computer-readable memories of claim 11 further include receiving user feedback to the suggestion. In another example, the one or more computer-readable memories further include generating one or more tree structures in response to the user feedback.

A further example includes a method for automating operations performed on an electronic device employed by a user, including: capturing signals that represent occurrences of events that are local to the device over a time interval; identifying one or more chains of events from the captured signals; determining a probability that a chain of events leads to a launch of an application on the device by the user; determining a level of confidence in the probability; and automatically launching an application when the probability exceeds a predetermined probability threshold and the level exceeds a predetermined confidence threshold.

In another example, the method further includes capturing within-application events that represent events or state associated with the application and determining a probability that a chain of events leads to an initiation of a within-application activity. In another example, the method of claim further includes automatically initiating one or more within-application activities based on the probability that a chain of events leads to an initiation of a within-application activity. In another example, the method further includes supporting a digital assistant on the electronic device and utilizing the digital assistant to obtain a confirmation from the user prior to the automatic launching. In another example, the method further includes configuring the digital assistant, responsively to voice input, gesture input, or manual input for performing at least one of interacting with the user, performing tasks, performing services, gathering information, operating the electronic device, or operating external devices. In another example, the method further includes exposing a user interface (UI) for collecting user feedback. In another example, the method further includes configuring a machine learning system to perform the identifying and probability determination and implementing a feedback loop to provide the user feedback to the machine learning system.

Based on the foregoing, it should be appreciated that technologies for behavior recognition and automation using a mobile device have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A mobile device, comprising:
one or more processors;
a user interface (UI) configured to interact with a user of the device using one of visual display or audio; and
a memory device storing computer-readable instructions which, when executed by the one or more processors, perform an automated method for launching applications or initiating within-application activities, comprising
collecting signals representing events that are occurring locally on the device,
analyzing the collected signals to identify recurring patterns of sequences of events that result in an application launch or an initiation of one or more within-application activities,
using the recurring patterns to make a prediction of a future application launch or a future initiation of one or more within-application activities, and
automatically operating the device to launch an application or initiating one or more within-application activities responsively to the prediction.

2. The mobile device of claim 1 further including collecting at least a portion of the signals from a digital assistant that is supported on the device in which the digital assistant interacts with the user through the UI.

3. The mobile device of claim 1 further including performing the analyzing using one of Bayesian network, neural network, regression, or classification.

4. The mobile device of claim 1 in which the events include one or more of application launch events initiated by the user, within-application activity events initiated by the user, activity events including idle, stationary, walking, or running, driving events including vehicle telemetry, audio routing events including using an audio endpoint, geofence boundary crossing events, wireless network connection or disconnection events, short range network connection or disconnection events, battery charge state events, charger connection or disconnection events, alarm creation events, alarm deletion events, or lock state events.

5. The mobile device of claim 1 further including tracking a frequency of occurrences of events and launching the application or initiating the within-application activities responsively at least in part to the tracked frequency.

6. The mobile device of claim 1 further including using a digital assistant to support interactions with the user including participating in conversations and making suggestions for automated actions.

7. One or more computer-readable memories storing instructions which, when executed by one or more processors disposed in a device, implement a machine learning system adapted for:
receiving signals that are indicative of occurrences of events on the device;
creating an event history using the received signals, in which event history is represented using one or more tree structures including event occurrences by type that are populated into a probabilistic directed graph;
calculating a probability of an event using the event history; and
triggering an action responsively to the calculated probability.

8. The one or more computer-readable memories of claim 7 further including counting event occurrences in the one or more tree structures to generate a confidence level for the event probability and triggering the action, at least in part, responsively to confidence level.

9. The one or more computer-readable memories of claim 7 in which the action includes an automated application launch or an automated initiation of a within-application activity.

10. The one or more computer-readable memories of claim 7 further including making a request to a device user for confirmation of the action prior to the triggering.

11. The one or more computer-readable memories of claim 7 further including triggering a suggestion for an action and exposing the suggestion through a user interface to a device user.

12. The one or more computer-readable memories of claim 11 further including receiving user feedback to the suggestion.

13. The one or more computer-readable memories of claim 12 further including generating one or more tree structures in response to the user feedback.

14. A method for automating operations performed on an electronic device employed by a user, including:
capturing signals that represent occurrences of events that are local to the device over a time interval;
identifying one or more chains of events from the captured signals;
determining a probability that a chain of events leads to a launch of an application on the device by the user;
determining a level of confidence in the probability; and
automatically launching an application when the probability exceeds a predetermined probability threshold and the level exceeds a predetermined confidence threshold.

15. The method of claim 14 further including capturing within-application events that represent events or state associated with the application and determining a probability that a chain of events leads to an initiation of a within-application activity.

16. The method of claim 15 further including automatically initiating one or more within-application activities based on the probability that a chain of events leads to an initiation of a within-application activity.

17. The method of claim 14 further including supporting a digital assistant on the electronic device and utilizing the digital assistant to obtain a confirmation from the user prior to the automatic launching.

18. The method of claim 17 further including configuring the digital assistant, responsively to voice input, gesture input, or manual input for performing at least one of interacting with the user, performing tasks, performing services, gathering information, operating the electronic device, or operating external devices.

19. The method of claim 14 further including exposing a user interface (UI) for collecting user feedback.

20. The method of claim 19 further including configuring a machine learning system to perform the identifying and probability determination and implementing a feedback loop to provide the user feedback to the machine learning system.
